(19) United States
(12) Patent Application Publication
(10) Pub. No.: US 2026/0292701 A1
(43) Pub. Date: Sep. 24, 2026

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(21) Appl. No.: 19/687,471

(22) Filed: May 26, 2026

Related U.S. Application Data
(63) Continuation of application No. PCT/CN2023/135948, filed on Dec. 1, 2023.

(51) Int. Cl. H04W 52/02

(52) U.S. Cl. CPC H04W 52/0235; H04W 52/0216

(57) ABSTRACT

A terminal device receives a low power wake-up signal (LP-WUS) transmitted by a network device, where the LP-WUS is used for controlling monitoring, by a main radio (MR) of the terminal device, of a first physical downlink control channel (PDCCH) and/or a second PDCCH, the first PDCCH is a PDCCH indicating unicast scheduling, and the second PDCCH is a PDCCH indicating multicast and/or broadcast scheduling.

### CROSS-REFERENCE TO RELATED APPLICATION(S)

This application is a continuation of International Application No. PCT/CN 2023/135948, filed Dec. 1, 2023, the entire disclosure of which is incorporated herein by reference.

### TECHNICAL FIELD

Embodiments of the present disclosure relate to the field of mobile communication technologies, and in particular, to a wireless communication method, a terminal device, and a network device.

### BACKGROUND

In a New Radio (NR) system, a network device may configure a Discontinuous Reception (DRX) function for a terminal device, so that the terminal device monitors a Physical Downlink Control Channel (PDCCH) discontinuously, thereby achieving power saving for the terminal device.

Services include unicast services and Multimedia Broadcast Service (MBS). The development of NR MBS enables multimedia content to be transmitted to mobile terminals through broadcast transmission, allowing users to watch broadcast television programs or receive data push services anytime and anywhere. In receiving broadcast and multicast data, power-saving considerations for terminal devices also need to be taken into account.

### SUMMARY

A wireless communication method provided by embodiments of the present disclosure includes the following. A terminal device receives a low power wake-up signal (LP-WUS) transmitted by a network device, where the LP-WUS is used for controlling monitoring of a first Physical Downlink Control Channel (PDCCH) and/or a second PDCCH by a main radio (MR) of the terminal device, the first PDCCH is a PDCCH indicating unicast scheduling, and the second PDCCH is a PDCCH indicating multicast and/or broadcast scheduling.

A terminal device provided by embodiments of the present disclosure includes a processor and a memory configured to store a computer program which, when executed by the processor, causes the terminal device to receive an LP-WUS transmitted by a network device, where the LP-WUS is used for controlling monitoring of a first PDCCH and/or a second PDCCH by an MR of the terminal device, the first PDCCH is a PDCCH indicating unicast scheduling, and the second PDCCH is a PDCCH indicating multicast and/or broadcast scheduling.

A network device provided by embodiments of the present disclosure includes a processor and a memory configured to store a computer program which, when executed by the processor, causes the network device to transmit an LP-WUS to a terminal device, where the LP-WUS is used for controlling transmission of a first PDCCH and/or a second PDCCH to the terminal device, the first PDCCH is a PDCCH indicating unicast scheduling, and the second PDCCH is a PDCCH indicating multicast and/or broadcast scheduling.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

The drawings described herein are provided for further understanding of the present disclosure and constitute a part of the present disclosure. The schematic embodiments of the present disclosure and descriptions thereof are used for explaining the present disclosure and do not constitute an improper limitation of the present disclosure. In the drawings:

FIG. 1 is a schematic diagram of an application scenario according to an embodiment of the present disclosure;

FIG. 2 is a schematic diagram of a DRX cycle according to an embodiment of the present disclosure;

FIG. 3 is a schematic diagram of a PTP transmission mode according to an embodiment of the present disclosure;

FIG. 4 is a schematic diagram of a PTM transmission mode according to an embodiment of the present disclosure;

FIG. 5 is a schematic diagram of an optional transmission of an LP-WUS provided by an embodiment of the present disclosure;

FIG. 6 is a schematic diagram of an optional transmission of an LP-WUS provided by an embodiment of the present disclosure;

FIG. 7 is an optional schematic flowchart of a wireless communication method provided by an embodiment of the present disclosure;

FIG. 8 is an optional schematic flowchart of a wireless communication method provided by an embodiment of the present disclosure;

FIG. 9 is an optional schematic flowchart of a wireless communication method provided by an embodiment of the present disclosure;

FIG. 10 is an optional schematic structural diagram of a terminal device provided by an embodiment of the present disclosure;

FIG. 11 is an optional schematic structural diagram of a network device provided by an embodiment of the present disclosure;

FIG. 12 is a schematic structural diagram of a communication device provided by an embodiment of the present disclosure;

FIG. 13 is a schematic structural diagram of a chip according to an embodiment of the present disclosure; and

FIG. 14 is a schematic block diagram of a communication system provided by an embodiment of the present disclosure.

### DETAILED DESCRIPTION

The technical solutions in the embodiments of the present disclosure will be described below with reference to the drawings in the embodiments of the present disclosure. Apparently, the described embodiments are only a part of the embodiments of the present disclosure, rather than all embodiments. Based on the embodiments in the present disclosure, all other embodiments obtained by those of ordinary skill in the art without making creative efforts shall fall within the protection scope of the present disclosure.

Communication system scenarios include Terrestrial Networks (TN) and Non-Terrestrial Networks (NTN). NTN generally uses satellite communication to provide communication services to ground users. Currently, NTN systems include NR-NTN and IoT-NTN systems, and may include other NTN systems in the future.

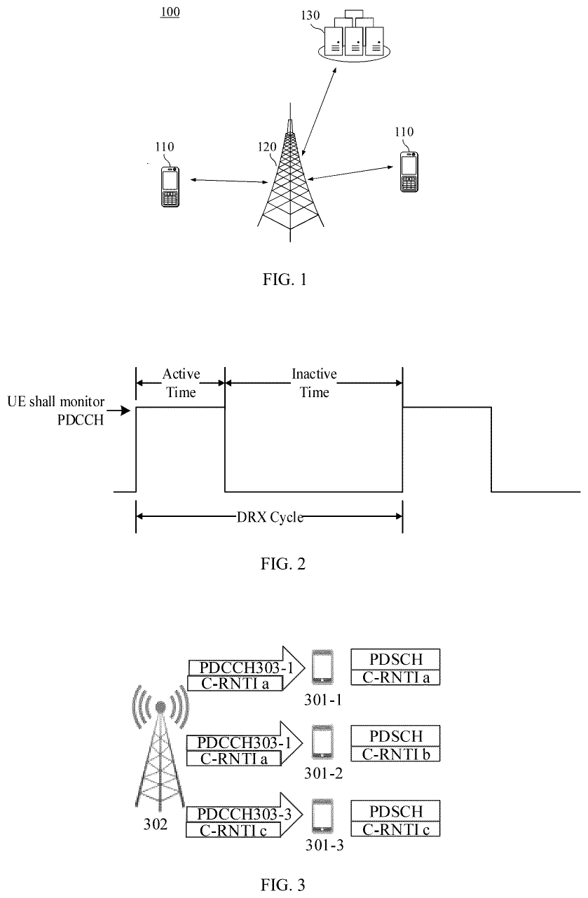

FIG. 1 is a schematic diagram of an architecture of a communication system according to an embodiment of the present disclosure. As illustrated in FIG. 1, a communication system 100 may include a terminal device 110 and a network device 120. The network device 120 may communicate with the terminal device 110 through an air interface. Multi-service transmission between the terminal device 110 and the network device 120 is supported.

It should be understood that the communication system 100 is used as an example for illustration only in the embodiment of the present disclosure, but the embodiment of the present disclosure is not limited thereto. That is, the technical solution of the embodiment of the present disclosure may be applied to various communication systems, such as: Long Term Evolution (LTE) systems, LTE Time Division Duplex (TDD), Universal Mobile Telecommunication System (UMTS), Internet of Things (IoT) systems, Narrow Band Internet of Things (NB-IoT) systems, enhanced Machine-Type Communications (eMTC) systems, 5G communication systems (also called New Radio (NR) communication systems), or future communication systems, etc.

In the communication system 100 illustrated in FIG. 1, the network device 120 may be an access network device communicating with the terminal device 110. The access network device may provide communication coverage for a specific geographic area and may communicate with the terminal device 110 (e.g., UE) located in the coverage area.

The network device 120 may be an Evolved Node B (eNB or eNodeB) in an LTE system, or a Next Generation Radio Access Network (NG RAN) device, or a base station (gNB) in an NR system, or a radio controller in a Cloud Radio Access Network (CRAN), or the network device 120 may be a relay station, an access point, a vehicle-mounted device, a wearable device, a hub, a switch, a bridge, a router, or a network device in a future evolved Public Land Mobile Network (PLMN), etc.

The terminal device 110 may be any terminal device, including but not limited to terminal devices connected to the network device 120 or other terminal devices by wired or wireless connections.

For example, the terminal device 110 may refer to an access terminal, User Equipment (UE), a user unit, a subscriber station, a mobile station, a mobile unit, a remote station, a remote terminal, a mobile device, a user terminal, a terminal, a wireless communication device, a user agent, or a user apparatus. The access terminal may be a cellular phone, a cordless phone, a Session Initiation Protocol (SIP) phone, an IoT device, a satellite handheld terminal, a Wireless Local Loop (WLL) station, a Personal Digital Assistant (PDA), a handheld device with wireless communication function, a computing device or other processing device connected to a wireless modem, a vehicle-mounted device, a wearable device, a terminal device in a 5G network, or a terminal device in a future evolved network, etc.

The terminal device 110 may be used for Device to Device (D2D) communication.

The wireless communication system 100 may also include a core network device 130 communicating with the base station. The core network device 130 may be a 5G Core (5GC) device, for example, an Access and Mobility Management Function (AMF), an Authentication Server Function (AUSF), a User Plane Function (UPF), or a Session Management Function (SMF). Optionally, the core network device 130 may also be an Evolved Packet Core (EPC) device in an LTE network, for example, a Session Management Function+Core Packet Gateway (SMF+PGW-C) device. It should be understood that the SMF+PGW-C may simultaneously implement functions that can be implemented by both SMF and PGW-C. In the network evolution process, the above core network devices may also be called by other names, or new network entities may be formed by dividing the functions of the core network, which is not limited in this embodiment of the present disclosure.

Various functional units in the communication system 100 may also establish connections for communication through Next Generation (NG) interfaces.

For example, a terminal device establishes an air interface connection with an access network device through a Uu interface for transmitting user plane data and control plane signaling; the terminal device may establish a control plane signaling connection with an AMF through an NG interface 1 (abbreviated as N1); an access network device such as a next generation radio access base station (gNB) may establish a user plane data connection with a UPF through an NG interface 3 (abbreviated as N3); the access network device may establish a control plane signaling connection with an AMF through an NG interface 2 (abbreviated as N2); the UPF may establish a control plane signaling connection with an SMF through an NG interface 4 (abbreviated as N4); the UPF may interact user plane data with a data network through an NG interface 6 (abbreviated as N6); the AMF may establish a control plane signaling connection with an SMF through an NG interface 11 (abbreviated as N11); the SMF may establish a control plane signaling connection with a PCF through an NG interface 7 (abbreviated as N7).

FIG. 1 exemplarily illustrates one base station, one core network device, and two terminal devices. Optionally, the wireless communication system 100 may include multiple base station devices, and other numbers of terminal devices may be located in the coverage of each base station, which is not limited in the embodiment of the present disclosure.

It should be noted that FIG. 1 only schematically shows a system to which the present disclosure is applicable. The method illustrated in the embodiment of the present disclosure may also be applicable to other systems. In addition, the terms “system” and “network” are often used interchangeably herein. The term “and/or” herein represents merely an association relationship describing associated objects, indicating that there may be three relationships. For example, A and/or B may indicate: A exists alone, both A and B exist simultaneously, and B exists alone. In addition, the character “/” herein generally indicates that the associated objects before and after that character have an “or” relationship. It should also be understood that “indication” in the embodiments of the present disclosure may be direct indication, indirect indication, or indicating an association relationship. For example, A indicates B, which may mean that A directly indicates B (for example, B may be obtained through A), or may mean that A indirectly indicates B (for example, A indicates C, and B may be obtained through C), or may mean that there is an association relationship between A and B. It should also be understood that “corresponding” in the embodiments of the present disclosure may indicate a direct or indirect correspondence between the two, or may indicate an association relationship between the two, or may indicate an indicating and indicated, or configuring and configured relationship. It should also be understood that “predefined” or “predefined rule” in the embodiments of the present disclosure may be implemented by pre-saving corresponding codes, tables, or other means for indicating relevant information in a device (for example, including a terminal device and a network device), and the specific implementation manner is not limited in the present disclosure. For example, predefined may refer to definition in a protocol. It should also be understood that in the embodiments of the present disclosure, the “protocol” may refer to standard protocols in the communication field, for example, including LTE protocols, NR protocols, and related protocols applied in future communication systems, which is not limited in the present disclosure.

To facilitate understanding of the technical solutions of the embodiments of the present disclosure, the following describes relevant technologies of the embodiments of the present disclosure. The following relevant technologies may be optionally combined with the technical solutions of the embodiments of the present disclosure, and all belong to the protection scope of the embodiments of the present disclosure.

As people's pursuit of rate, delay, high-speed mobility, and energy efficiency, as well as the diversity and complexity of services in future life, the 3rd Generation Partnership Project (3GPP) international standards organization began to develop the 5th generation (5G). The main application scenarios of 5G include: Enhanced Mobile Broadband (eMBB), Ultra Reliable and Low Latency Communication (URLLC), and Massive Machine-Type Communication (mMTC).

In a 5G network environment, in order to reduce air interface signaling and quickly restore wireless connections and quickly restore data services, a new Radio Resource Control (RRC) state is defined, namely the RRC_INACTIVE state. This state is different from the idle state (RRC_IDLE state) and the active state (RRC_ACTIVE state).

RRC_IDLE: mobility is based on cell selection and re-selection of a UE. Paging is initiated by a CN, and a paging area is configured by the CN. The BS side does not have UE access stratum (AS) context. There is no RRC connection.

RRC_CONNECTED: there is an RRC connection. Both the BS and the UE have the UE AS context. The network side knows the location of the UE at the cell level. Mobility is controlled by the network side. Unicast data can be transmitted between the UE and the BS.

RRC_INACTIVE: mobility is based on cell selection and re-selection of the UE. There is a CN-NR connection. A certain BS has the UE AS context. Paging is triggered by a radio access network (RAN), a RAN-based paging area is managed by the RAN, and the network side knows the location of the UE at the RAN-based paging area level.

In NR, the network device may configure a Discontinuous Reception (DRX) function for the terminal device, so that the terminal discontinuously monitors a Physical Downlink Control Channel (PDCCH), thereby achieving power saving for the terminal device. DRX is mainly used to control the MAC entity of the terminal device to monitor a Cell-Radio Network Temporary Identifier (C-RNTI), a cancellation indication-RNTI (CI-RNTI), a Configured Scheduling RNTI (CS-RNTI), an Interruption RNTI (INT-RNTI), a Slot Format Indication RNTI (SFI-RNTI), a Semi-Persistent channel state information RNTI (SP-CSI-RNTI), a Transmit Power Control (TPC)-Physical Uplink Control Channel (PUCCH)-RNTI, a TPC-Physical Uplink Shared Channel (PUSCH)-RNTI, a TPC-SRS-RNTI, an AI-RNTI, an SL-RNTI, an SLCS-RNTI, and an SL Semi-Persistent Scheduling V-RNTI.

The basic mechanism of DRX is to configure a DRX cycle for the terminal device. As illustrated in FIG. 2, the DRX cycle consists of an active time (On Duration) and an inactive time (Opportunity for DRX). During the On Duration, the terminal device monitors and receives PDCCH. During the Opportunity for DRX, the terminal device does not receive downlink channel data to save power. As illustrated in FIG. 2, in the time domain, time is divided into successive DRX Cycles.

Each MAC entity has a DRX configuration. The DRX configuration parameters include:

DRX on-duration timer (drx-onDurationTimer): specifies a continuous duration (i.e., duration of the active time) for which PDCCH needs to be monitored, starting from a starting subframe of the DRX cycle;

DRX slot offset (drx-SlotOffset): a delay for the UE to start the drx-onDurationTimer;

DRX inactivity timer (drx-InactivityTimer): indicates a continuous duration for which the terminal device continues to monitor PDCCH (i.e., a continuous duration for which the terminal device continues to be in the active time) after the terminal device receives a PDCCH indicating an uplink initial transmission or a downlink initial transmission;

DRX downlink retransmission timer (drx-RetransmissionTimerDL): specifies the maximum continuous duration for which the terminal device monitors a PDCCH indicating downlink retransmission scheduling, where each downlink HARQ process except the broadcast process corresponds to a drx-RetransmissionTimerDL;

DRX uplink retransmission timer (drx-RetransmissionTimerUL): indicates the maximum continuous duration for which the terminal device monitors a PDCCH indicating uplink retransmission scheduling, where each uplink HARQ process corresponds to a drx-RetransmissionTimerUL;

DRX long cycle start offset (drx-LongCycleStartOffset): used for configuring a long DRX cycle, and a subframe offset for the start of the long DRX cycle and a short DRX cycle;

Short DRX Cycle: an optional configuration;

Short DRX cycle duration (drx-ShortCycle): a duration for which the UE is in a short DRX cycle (and has not received any PDCCH), which is an optional configuration;

DRX HARQ downlink round-trip-time timer (drx-HARQ-RTT-TimerDL): the minimum waiting time for which the terminal device is expected to receive a PDCCH indicating downlink scheduling, where each downlink HARQ process except the broadcast process corresponds to a drx-HARQ-RTT-TimerDL;

DRX HARQ uplink round-trip-time timer (drx-HARQ-RTT-TimerUL): the minimum waiting time for which the terminal device is expected to receive a PDCCH indicating uplink scheduling, where each uplink HARQ process corresponds to a drx-HARQ-RTT-TimerUL.

If the terminal device is configured with DRX, the terminal device needs to monitor PDCCH during a DRX active time. The DRX active time includes the following situations:
any of 5 timers, namely drx-onDurationTimer, drx-InactivityTimer, drx-RetransmissionTimerDL, drx-RetransmissionTimerUL, and a random access contention resolution timer ra-ContentionResolutionTimer, is running;
a Scheduling Request (SR) has been transmitted on a Physical Uplink Control Channel (PUCCH) and is in a pending state;
in a contention-based random access process, after successfully receiving a random access response, an initial transmission indicated by a PDCCH scrambled by a C-RNTI has not yet been received.

In the existing mechanism, the DRX long DRX cycle is a default configuration, and the DRX short DRX cycle is an optional configuration. For a terminal configured with a short DRX cycle, the protocol currently specifies a conversion method between the long DRX cycle and the short DRX cycle. Specifically:

When any of the following conditions is met, the terminal uses a DRX short cycle:
the drx-InactivityTimer expires;
the terminal receives a DRX command MAC CE.

When any of the following conditions is met, the terminal uses a DRX long cycle:
the drx-ShortCycleTimer expires;
the terminal receives a long DRX command MAC CE.

The terminal determines the time to start the drx-onDurationTimer based on whether it is currently in a short DRX cycle or a long DRX cycle. The specific provisions are as follows:

If using a Short DRX Cycle, and the current subframe satisfies [(SFN×10)+subframe number] modulo (drx-ShortCycle)=(drx-StartOffset) modulo (drx-ShortCycle), or if using a Long DRX Cycle, and the current subframe satisfies [(SFN×10)+subframe number] modulo (drx-LongCycle)=drx-StartOffset, then the drx-onDurationTimer is started after drx-SlotOffset slots from the start of the current subframe.

The condition for the terminal to start or restart the drx-InactivityTimer is: if the terminal receives a PDCCH indicating a downlink or uplink initial transmission, the terminal starts or restarts the drx-InactivityTimer.

The conditions for the terminal to start and stop the drx-RetransmissionTimerDL are as follows.

When the terminal receives a PDCCH indicating a downlink transmission, or when the terminal receives a MAC PDU on a configured DL grant resource, the terminal stops the drx-RetransmissionTimerDL corresponding to this HARQ process. The terminal starts the drx-HARQ-RTT-TimerDL corresponding to this HARQ process after completing the transmission of the HARQ process feedback for this downlink transmission.

If the drx-HARQ-RTT-TimerDL corresponding to a certain HARQ of the terminal expires, and the downlink data transmitted using this HARQ process is not successfully decoded, the terminal starts the drx-RetransmissionTimerDL corresponding to this HARQ process.

The conditions for the terminal to start and stop the drx-RetransmissionTimerUL are as follows.

When the terminal receives a PDCCH indicating an uplink transmission, or when the terminal transmits a MAC PDU on a configured UL grant resource, the terminal stops the drx-RetransmissionTimerUL corresponding to this HARQ process. The terminal starts the drx-HARQ-RTT-TimerUL corresponding to this HARQ process after completing the first repetition of this PUSCH.

If the drx-HARQ-RTT-TimerUL corresponding to a certain HARQ of the terminal expires, the terminal starts the drx-RetransmissionTimerUL corresponding to this HARQ process.

### NR Multimedia Broadcast Service (MBS)

Traditional video software transmits data content in unicast form. When there are too many users, the network becomes overwhelmed and congestion occurs. When multiple users in a wireless cell watch video content simultaneously, the wireless downlink rate may be the bottleneck. In this case, broadcasting in the wireless cell can ensure smooth viewing for users. The development of 5G NR MBS enables multimedia content to be transmitted to mobile terminals through broadcast transmission, allowing users to watch broadcast television programs or receive data push services anytime and anywhere.

In the Rel-17 NR MBS physical layer design, depending on the connection state of the UE receiving MBS, the name of MBS is slightly different. Multicast (or groupcast) is when the network transmits MBS services to a group of UEs in the connected state, and the base station transmits a group common PDCCH (CRC scrambled with G-RNTI or G-CS-RNTI) to schedule a group common PDSCH. Broadcast is when the network device transmits MBS services to UEs within coverage, and the connection state of the UE may be connected or non-connected, and the base station transmits a group common PDCCH (CRC scrambled with MCCH-RNTI or G-RNTI) to schedule a group common PDSCH.

For UEs in the connected state, NR MBS multicast scheduling supports the following two transmission modes:
Point to Point (PTP) transmission mode: For a UE in the connected state, the base station transmits a dedicated PDCCH to this UE. The CRC of the PDCCH is scrambled with a UE-specific RNTI (such as C-RNTI). The UE-specific PDCCH indicates a UE-specific PDSCH, and the indicated PDSCH is scrambled with the same UE-specific RNTI.
Point to Multi-point (PTM) transmission mode: For a group of UEs in the connected state, the base station transmits a group common PDCCH to this group of UEs. The CRC of the PDCCH is scrambled with a group common RNTI. The group common PDCCH is used to schedule a group common PDSCH, and the scheduled PDSCH is scrambled with the same group common RNTI.

The PTP transmission mode can only be used as a transmission mode for retransmission in the MBS.

In an example, the PTP mode is illustrated in FIG. 3. For UE 301-1, UE 301-2, and UE 301-3, a base station 302 transmits a PDCCH 303-1 using C-RNTIa, a PDCCH 303-2 using C-RNTIb, and a PDCCH 303-3 using C-RNTIc, respectively. The PDCCH 303-1 using C-RNTIa is used to schedule a PDSCH dedicated to UE 301-1, the PDCCH 303-2 using C-RNTIb is used to schedule a PDSCH dedicated to UE 301-2, and the PDCCH 303-3 using C-RNTIc is used to schedule a PDSCH dedicated to UE 301-3. The PDSCH dedicated to UE 301-1 is scrambled with C-RNTIa, the PDSCH dedicated to UE 301-2 is scrambled with C-RNTIb, and the PDSCH dedicated to UE 301-3 is scrambled with C-RNTIc.

In an example, the PTM transmission mode is illustrated in FIG. 4. For UE 301-1, UE 301-2, and UE 301-3, a base station 302 transmits a group common PDCCH (GC-PDCCH) to UE 301-1, UE 301-2, and UE 301-3. The GC-PDCCH is scrambled with G-RNTI, and the GC-PDCCH is used to schedule a GC-PDSCH. The GC-PDSCH is scrambled with G-RNTI.

The base station may configure two HARQ-ACK feedback modes for connected UEs: a first HARQ-ACK mode (acknowledgment or negative acknowledgment (ACK/NACK)) and a second HARQ-ACK mode (NACK-only).

When the base station configures the first HARQ-ACK mode for the UE, the base station schedules an initial transmission of a TB to a group of UEs through the PTM transmission mode. Based on the feedback from each UE (ACK, NACK, or no feedback), the base station schedules a retransmission of this TB using the PTM transmission mode or the PTP transmission mode.

When the base station configures the second HARQ-ACK mode for the UE, the base station schedules an initial transmission of a TB to a group of UEs through the PTM transmission mode. If one or more UEs feed back NACK, the base station schedules a retransmission of this TB using the PTM transmission mode.

DRX Mechanism for MBS Broadcast

The reception of broadcast service data also needs to consider the issue of UE energy saving, so broadcast MBS DRX is also supported. Broadcast MBS DRX is configured per G-RNTI, and broadcast MBS DRXs are independent of each other and independent of unicast DRX and multicast MBS DRX. The independence of broadcast MBS DRXs can be understood as the independence of MBS DRXs between different broadcast services.

The configuration parameters of broadcast MBS DRX include: drx-onDurationTimerPTM, drx-SlotOffsetPTM, drx-InactivityTimerPTM, and drx-LongCycleStartOffsetPTM.

When [(SFN×10)+subframe number] modulo (drx-LongCycle-PTM)=drx-StartOffset-PTM is satisfied, the timer drx-onDurationTimerPTM is started. When a downlink PDCCH scheduling is received, the timer drx-InactivityTimerPTM is started. For a certain G-RNTI, if the network configures DRX for this G-RNTI, the PDCCH scrambled with this G-RNTI is only monitored when the timer drx-onDurationTimerPTM or drx-InactivityTimerPTM is running.

### DRX Mechanism for MBS Multicast

The reception of multicast service data also needs to consider the issue of UE energy saving, so multicast MBS DRX is also supported. Multicast MBS DRX is configured per G-RNTI/G-CS-RNTI, and multicast MBS DRXs are independent of each other and independent of unicast DRX.

The configuration parameters of multicast MBS DRX include: drx-onDurationTimerPTM, drx-SlotOffsetPTM, drx-InactivityTimerPTM, drx-LongCycleStartOffsetPTM, drx-RetransmissionTimerDL-PTM, and drx-HARQ-RTT-TimerDL-PTM. Multicast DRX supports per G-RNTI/G-CS-RNTI DRX command, that is, the DRX command is transmitted scrambled with G-RNTI, and the DRX command is used for the multicast MBS DRX corresponding to this G-RNTI.

For a certain G-RNTI, if the network configures DRX for this G-RNTI, the PDCCH scrambled with this G-RNTI is only monitored when the timer drx-onDurationTimerPTM, drx-InactivityTimerPTM, or drx-RetransmissionTimerDL-PTM is running.

The operation of DRX is similar to unicast DRX, but in multicast MBS, due to the introduction of NACK-only HARQ feedback mode, HARQ feedback deactivation mode, and PTP for PTM retransmission, multicast MBS DRX has its own particularities.

When the HARQ feedback deactivation mode is used, the UE has no HARQ feedback, so the UE does not start the drx-HARQ-RTT-TimerDL-PTM timer and the drx-RetransmissionTimerDL-PTM timer.

When the NACK-only HARQ feedback mode is used, if the received MAC PDU is correctly decoded, the UE has no HARQ feedback, so the UE does not start the drx-HARQ-RTT-TimerDL-PTM timer and the drx-RetransmissionTimerDL-PTM timer.

When the PTP for PTM retransmission mode is used, if HARQ feedback exists, the UE is uncertain whether the retransmission data comes from PTM or PTP, so both the unicast drx-HARQ-RTT-TimerDL timer and the multicast MBS DRX drx-HARQ-RTT-TimerDL-PTM timer are started.

### Connected State WUS

In NR R16, a power saving signal (WUS) is introduced. The UE starts blind detection of PDCCH-based power saving signalling (also called PDCCH-WUS) at an offset moment before the drx-ondurationTimer start moment corresponding to each long DRX cycle. If the PDCCH-WUS is detected and the WUS indicates that the UE should wake up, the UE starts the drx-ondurationTimer in this Long DRX cycle. If the PDCCH-WUS is detected and the WUS indicates the UE should not wake up, the UE does not start the drx-ondurationTimer.

The above connected-state power saving technologies are designed for terminals where the main radio is always on, including the DRX mechanism and the WUS mechanism. Compared with the WUS mechanism, the ultra-low power WUS (LP-WUS) is more energy-saving, where a receiver consuming lower power is used, that is, the main radio is not used. The terminal device starts the main radio after receiving the LP-WUS to monitor downlink signals, thereby achieving energy saving.

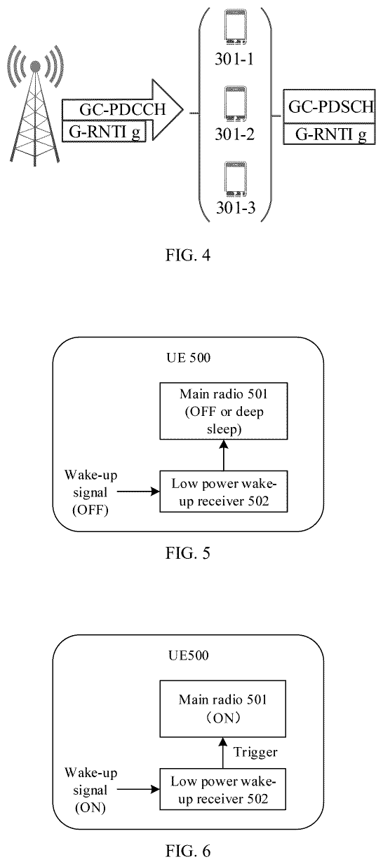

The working principle of LP-WUS is illustrated in FIG. 5 and FIG. 6. A UE 200 includes a Main Radio (MR) 501 and a lower power wake-up receiver (LR) 502. The UE receives a wake-up signal indicating off or on based on the LP wake-up receiver 502. As illustrated in FIG. 5, when the LP wake-up receiver 502 receives a wake-up signal indicating off, the main radio 501 maintains an off or deep sleep state. As illustrated in FIG. 6, when the LP wake-up receiver 502 receives a wake-up signal indicating on, the LP wake-up receiver 502 triggers the main radio 501 to turn on.

After the introduction of the LP-WUS signal, it is necessary to study its impact on UEs in the connected state. Based on current understanding, the impact of LP-WUS on connected-state UEs is: LP-WUS is used to restore the monitoring of PDCCH by the main radio of the UE. Then, for UEs that simultaneously support and are configured with both unicast services and MBS services, how to use the LP-WUS to control the reception of unicast service and MBS service scheduling is a problem that needs to be studied.

To facilitate understanding of the technical solutions of the embodiments of the present disclosure, the technical solutions of the present disclosure are described in detail below through specific embodiments. The above relevant technologies may be optionally combined with the technical solutions of the embodiments of the present disclosure, and all belong to the protection scope of the embodiments of the present disclosure. The embodiments of the present disclosure include at least part of the following content.

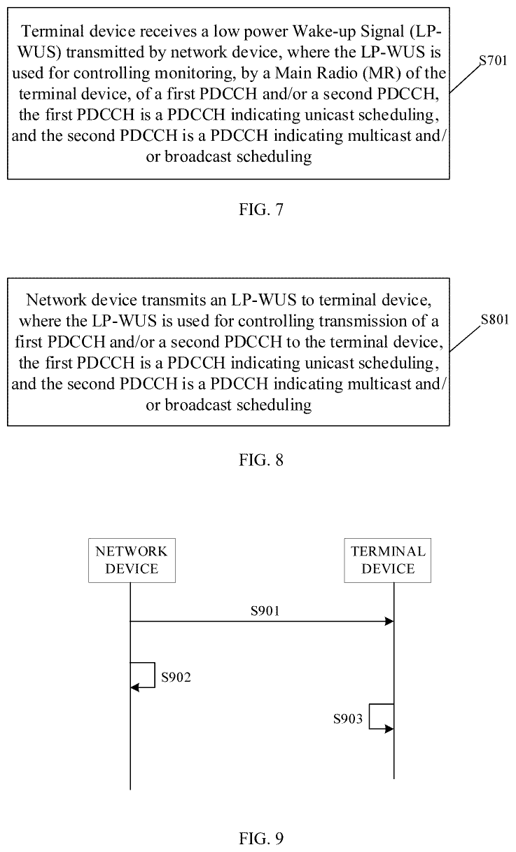

Embodiments of the present disclosure provide a wireless communication method applied to a terminal device. As illustrated in FIG. 7, the method includes the following.

S701: A terminal device receives a low power wake-up signal (LP-WUS) transmitted by a network device, where the LP-WUS is used for controlling monitoring, by a Main Radio (MR) of the terminal device, of a first PDCCH and/or a second PDCCH, the first PDCCH is a PDCCH indicating unicast scheduling, and the second PDCCH is a PDCCH indicating multicast and/or broadcast scheduling.

A low power wake-up receiver (LR) of the terminal device in a connected state monitors the LP-WUS transmitted by the network device. When the network device transmits the LP-WUS to the terminal device, the LR of the terminal device receives the LP-WUS transmitted by the network device, and the terminal device controls the monitoring, by the MR, of the first PDCCH and/or the second PDCCH based on the LP-WUS received by the LR. The first PDCCH indicates unicast scheduling, and the second PDCCH indicates multicast and/or broadcast scheduling.

The first PDCCH indicating unicast scheduling may be understood as the first PDCCH indicating a first PDSCH or a first PUSCH of a unicast service, or being used for scheduling the first PDSCH or the first PUSCH of the unicast service. The second PDCCH indicating multicast and/or broadcast scheduling may be understood as the second PDCCH indicating a second PDSCH of a multicast and/or broadcast service, or being used for scheduling the second PDSCH of the multicast and/or broadcast service.

In embodiments of the present disclosure, the first PDCCH and the first PDSCH or first PUSCH scheduled by the first PDCCH are scrambled with the same RNTI. The RNTI for scrambling the first PDCCH may include a C-RNTI or a CS-RNTI.

In embodiments of the present disclosure, the second PDCCH and the second PDSCH are scrambled with the same or different RNTIs. The RNTI for scrambling the second PDCCH may include a G-RNTI or a G-CS-RNTI.

In embodiments of the present disclosure, the LP-WUS being used for controlling the monitoring, by the MR, of the first PDCCH and/or the second PDCCH includes one or more of the following monitoring scenarios:

Monitoring scenario 1: controlling the monitoring of the first PDCCH;

Monitoring scenario 2: controlling the monitoring of the second PDCCH; and

Monitoring scenario 3: controlling the monitoring of the first PDCCH and controlling the monitoring of the second PDCCH.

In monitoring scenario 1, the LP-WUS is used for resuming monitoring of the first PDCCH by the MR, or maintaining non-monitoring of the first PDCCH by the MR, or maintaining monitoring, of the first PDCCH by the MR.

In monitoring scenario 2, the LP-WUS is used for resuming monitoring of the second PDCCH by the MR, or maintaining non-monitoring of the second PDCCH by the MR, or maintaining monitoring of the second PDCCH by the MR.

In monitoring scenario 3, the LP-WUS is used for simultaneously controlling the monitoring of the first PDCCH and the second PDCCH, where the control of the monitoring of the first PDCCH by the LP-WUS may refer to monitoring scenario 1, and the control of the monitoring of the second PDCCH by the LP-WUS may refer to monitoring scenario 2.

In embodiments of the present disclosure, when the terminal device receives the LP-WUS transmitted by the network device, based on the received LP-WUS, the terminal device controls the monitoring, by the MR, of a PDCCH indicating unicast scheduling and/or a PDCCH indicating multicast and/or broadcast scheduling. After the terminal device receives the LP-WUS, the monitoring of PDCCH(s) scheduling corresponding service(s) is controlled, thereby reducing service latency while minimizing the power consumption of the terminal device.

The wireless communication method illustrated in FIG. 7 provided by the embodiments of the present disclosure is further described below.

In some embodiments, the LP-WUS is used for controlling the monitoring, by the MR, of the first PDCCH and the second PDCCH.

Here, the manner in which the LP-WUS controls the monitoring of the first PDCCH and the second PDCCH is monitoring-control manner 1: the LP-WUS simultaneously controls the first PDCCH and the second PDCCH. The LP-WUS received by the terminal device is simultaneously used for controlling the first PDCCH and the second PDCCH.

For monitoring-control manner 1, the monitoring states (also called monitoring behaviors) of the first PDCCH and the second PDCCH are controlled using the same LP-WUS. It can be understood that the LP-WUS is intended for the first PDCCH and the second PDCCH by default.

Under monitoring-control manner 1, the scenario in which the LP-WUS is used for controlling the monitoring, by the MR, of the first PDCCH and/or the second PDCCH only include monitoring scenario 1.

The LR of the terminal device receives the LP-WUS, and the terminal device controls the monitoring, by the MR, of the first PDCCH and the second PDCCH based on the received LP-WUS.

In some embodiments, the LP-WUS indicating wake-up is used for waking up the monitoring, by the MR, of the first PDCCH and the second PDCCH.

In embodiments of the present disclosure, the LP-WUS may indicate wake-up or may not indicate wake-up. The LP-WUS indicating wake-up is used for waking up the monitoring, by the MR, of the first PDCCH and the second PDCCH.

Optionally, when the terminal device receives an LP-WUS not indicating wake-up, the monitoring states of the first PDCCH and the second PDCCH are maintained unchanged.

In some embodiments, the terminal device further implements the following.

Based on the LP-WUS indicating wake-up, the terminal device resumes the monitoring, by the MR, of the first PDCCH and the second PDCCH.

When the LR of the terminal device receives the LP-WUS indicating wake-up, the LR transmits a wake-up indication to the MR, and the MR resumes the monitoring of both the first PDCCH and the second PDCCH based on the wake-up indication.

After the MR resumes the monitoring of the first PDCCH and the second PDCCH, the terminal device is able to monitor the first PDCCH and the second PDCCH through the MR.

The terminal device being able to monitor the first PDCCH and the second PDCCH through the MR may be understood as that the terminal device is able to monitor the first PDCCH and the second PDCCH based on a certain mechanism (such as the DRX mechanism), but this does not mean that the monitoring of the first PDCCH and the second PDCCH is continuously performed.

Optionally, the terminal device monitors the first PDCCH during an active time of unicast DRX, and monitors the second PDCCH during an active time of multicast or broadcast DRX.

In some embodiments, the LP-WUS indicating wake-up is further used for controlling the MR to enter a wake-up state from a sleep state, where the MR resumes monitoring of the first PDCCH and the second PDCCH in the wake-up state.

The states of the MR include the wake-up state or the sleep state. The wake-up state may also be replaced with a working state, and the sleep state may also be replaced with an off state, a light sleep state, or a deep sleep state.

When the LR of the terminal device receives the LP-WUS indicating wake-up, the LR transmits a wake-up indication to the MR, and the MR enters the wake-up state from the sleep state based on the received wake-up indication, and resumes the monitoring of the first PDCCH and the second PDCCH in the wake-up state, i.e., while being in the wake-up state.

In some embodiments, the terminal device does not monitor the first PDCCH and the second PDCCH when the MR is in the sleep state.

Before the terminal device receives the LP-WUS indicating wake-up, the MR is in the sleep state, and does not monitor the first PDCCH and the second PDCCH in the sleep state. When the terminal device receives the LP-WUS indicating wake-up, the MR enters the wake-up state based on the received LP-WUS indicating wake-up, and resumes the monitoring of the first PDCCH and the second PDCCH in the wake-up state.

In the embodiments of the present disclosure, using the same LP-WUS to simultaneously control the monitoring, by the MR of the UE, of the PDCCH indicating unicast scheduling and the PDCCH indicating multicast and/or broadcast scheduling, thereby controlling the monitoring of different PDCCHs through the same LP-WUS, minimizes signaling overhead.

In some embodiments, the LP-WUS is used for controlling the monitoring, by the MR, of the first PDCCH and/or the second PDCCH indicated by the LP-WUS.

Here, the manner in which the LP-WUS controls the monitoring of the first PDCCH and the second PDCCH is monitoring-control manner 2: the LP-WUS is used for controlling the monitoring of the first PDCCH and/or the second PDCCH indicated by the LP-WUS itself.

In monitoring-control manner 2, the LP-WUS may indicate one or two of the first PDCCH and the second PDCCH, and the LP-WUS is used for controlling the monitoring, by the MR, of the PDCCH indicated by this LP-WUS.

In an example, the LP-WUS indicates the first PDCCH, and this LP-WUS is used for controlling the monitoring, by the MR, of the first PDCCH. In this case, the monitoring scenario is monitoring scenario 1.

In an example, the LP-WUS indicates the second PDCCH, and this LP-WUS is used for controlling the monitoring, by the MR, of the second PDCCH. In this case, the monitoring scenario is monitoring scenario 2.

In an example, the LP-WUS indicates the first PDCCH and the second PDCCH, and this LP-WUS is used for controlling the monitoring, by the MR, of the first PDCCH and the second PDCCH. In this case, the monitoring scenario is monitoring scenario 3.

In embodiments of the present disclosure, the LP-WUS may indicate the first PDCCH and/or the second PDCCH in a manner including but not limited to:
the LP-WUS carries an RNTI of the indicated first PDCCH and/or an RNTI of the indicated second PDCCH;
the LP-WUS carries a service identifier corresponding to the indicated first PDCCH and/or a service identifier corresponding to the indicated second PDCCH.

For monitoring-control manner 2, the monitoring states of the first PDCCH and the second PDCCH are controlled using the same LP-WUS. It can be understood that the LP-WUS is intended for the indicated first PDCCH and/or the indicated second PDCCH. The LP-WUS received by the terminal device can be used for controlling the monitoring of the first PDCCH and/or the second PDCCH, where the PDCCH for which the LP-WUS is intended is the PDCCH indicated by this LP-WUS.

The LR of the terminal device receives the LP-WUS, and the terminal device controls the monitoring, by the MR, of the first PDCCH and/or the second PDCCH indicated by the received LP-WUS based on the received LP-WUS.

In some embodiments, the LP-WUS indicating wake-up is used for waking up the monitoring, by the MR, of the first PDCCH and/or the second PDCCH indicated by the LP-WUS.

In the embodiments of the present disclosure, the LP-WUS may indicate wake-up or may not indicate wake-up. The LP-WUS indicating wake-up is further used for indicating the first PDCCH and/or the second PDCCH, and this LP-WUS is used for waking up the monitoring, by the MR, of the first PDCCH and/or the second PDCCH indicated by this LP-WUS.

Optionally, when the terminal device receives an LP-WUS not indicating wake-up, the monitoring states of the first PDCCH and/or the second PDCCH are maintained unchanged.

In some embodiments, the terminal device further implements the following.

Based on the LP-WUS indicating wake-up, the terminal device resumes the monitoring, by the MR, of the first PDCCH and/or the second PDCCH indicated by the LP-WUS.

When the LR of the terminal device receives the LP-WUS indicating wake-up, the LR transmits a wake-up indication to the MR, and the MR resumes the monitoring of the first PDCCH and/or the second PDCCH indicated by the LP-WUS based on the wake-up indication.

Based on different PDCCHs indicated by the LP-WUS, the wake-up of the MR is divided into the following situations.

Situation 1: if the LP-WUS indicates the first PDCCH, based on the LP-WUS indicating wake-up, the terminal device resumes the monitoring, by the MR, of the first PDCCH.

Situation 2: if the LP-WUS indicates the second PDCCH, based on the LP-WUS indicating wake-up, the terminal device resumes the monitoring, by the MR, of the second PDCCH.

Situation 3: if the LP-WUS indicates the first PDCCH and the second PDCCH, based on the LP-WUS indicating wake-up, the terminal device resumes the monitoring, by the MR, of the first PDCCH and the second PDCCH.

For situation 1, the LP-WUS indicates the first PDCCH, and the MR resumes the monitoring of the first PDCCH based on the wake-up indication.

After the MR of the terminal device resumes the monitoring of the first PDCCH, the terminal device is able to monitor the first PDCCH through the MR.

The terminal device being able to monitor the first PDCCH through the MR may be understood as the terminal device being able to monitor the first PDCCH based on a certain mechanism (such as the DRX mechanism), but this does not mean that the monitoring of the first PDCCH is continuously performed.

Optionally, the terminal device monitors the first PDCCH during an active time of unicast DRX.

In some embodiments, the monitoring state of the second PDCCH remains unchanged.

If the LP-WUS received by the terminal device indicates the first PDCCH, it can be understood that the LP-WUS does not indicate the second PDCCH, and this LP-WUS is not intended for controlling the second PDCCH. The terminal device maintains the monitoring state of the second PDCCH unchanged.

In an example, before the terminal device receives the LP-WUS, the monitoring state of the second PDCCH is monitoring. After receiving the LP-WUS, the MR of the terminal device resumes the monitoring of the first PDCCH and maintains the monitoring of the second PDCCH.

In an example, before the terminal device receives the LP-WUS, the monitoring state of the second PDCCH is non-monitoring. After receiving the LP-WUS, the MR of the terminal device resumes the monitoring of the first PDCCH and maintains the non-monitoring of the second PDCCH.

For situation 2, the LP-WUS indicates the second PDCCH, and the MR resumes the monitoring of the second PDCCH based on the wake-up indication.

After the MR of the terminal device resumes the monitoring of the second PDCCH, the terminal device is able to monitor the second PDCCH through the MR.

The terminal device being able to monitor the second PDCCH through the MR may be understood as the terminal device being able to monitor the second PDCCH based on a certain mechanism (such as the DRX mechanism), but this does not mean that the monitoring of the second PDCCH is continuously performed.

Optionally, the terminal device monitors the second PDCCH during an active time of multicast or broadcast DRX.

In some embodiments, the monitoring state of the first PDCCH remains unchanged.

If the LP-WUS received by the terminal device indicates the second PDCCH, it can be understood that the LP-WUS does not indicate the first PDCCH, and this LP-WUS is not intended for controlling the first PDCCH. The terminal device maintains the monitoring state of the first PDCCH unchanged.

In an example, before the terminal device receives the LP-WUS, the monitoring state of the first PDCCH is monitoring. After receiving the LP-WUS, the MR of the terminal device resumes the monitoring of the second PDCCH and maintains the monitoring of the first PDCCH.

In an example, before the terminal device receives the LP-WUS, the monitoring state of the first PDCCH is non-monitoring. After receiving the LP-WUS, the MR of the terminal device resumes the monitoring of the second PDCCH and maintains the non-monitoring of the first PDCCH.

For situation 3, the LP-WUS indicates the first PDCCH and the second PDCCH, and the MR resumes the monitoring of the first PDCCH and the second PDCCH based on the wake-up indication.

After the MR of the terminal device resumes the monitoring of the first PDCCH and the second PDCCH, the terminal device is able to monitor the first PDCCH and the second PDCCH through the MR.

The terminal device being able to monitor the first PDCCH and the second PDCCH through the MR may be understood as the terminal device being able to monitor the first PDCCH and the second PDCCH based on a certain mechanism (such as the DRX mechanism).

Optionally, the terminal device monitors the first PDCCH during an active time of unicast DRX, and monitors the second PDCCH during an active time of multicast or broadcast DRX.

In some embodiments, the LP-WUS used for indicating wake-up is further used for controlling the MR to enter a wake-up state from a sleep state, where the MR performs monitoring of the first PDCCH and/or the second PDCCH in the wake-up state.

When the LR of the terminal device receives the LP-WUS indicating wake-up, the LR transmits a wake-up indication to the MR. The MR enters the wake-up state from the sleep state based on the received wake-up indication, and resumes the monitoring of the first PDCCH and/or the second PDCCH indicated by the LP-WUS in the wake-up state, i.e., while being in the wake-up state.

In some embodiments, the terminal device does not monitor the first PDCCH and/or the second PDCCH when the MR is in the sleep state.

Before the terminal device receives the LP-WUS indicating wake-up, the MR is in the sleep state, and does not monitor the first PDCCH and/or the second PDCCH in the sleep state. When the terminal device receives the LP-WUS indicating wake-up, the MR enters the wake-up state based on the received LP-WUS indicating wake-up, and resumes the monitoring of the first PDCCH and/or the second PDCCH indicated by the LP-WUS in the wake-up state.

In embodiments of the present disclosure, behaviors of the MR of the terminal device in the sleep state include the following situations:

Monitoring situation 1: not monitoring the first PDCCH, not monitoring the second PDCCH;

Monitoring situation 2: not monitoring the first PDCCH, monitoring the second PDCCH;

Monitoring situation 3: monitoring the first PDCCH, not monitoring the second PDCCH.

In some embodiments, if the LP-WUS indicates the second PDCCH, the LP-WUS indicates one or more of the following:
a PDCCH indicating multicast scheduling and/or a PDCCH indicating broadcast scheduling; and
a PDCCH indicating multicast or broadcast scheduling and scrambled by an RNTI.

In embodiments of the present disclosure, different second PDCCHs are divided based on multicast and broadcast and/or divided based on different RNTIs. In the case where the second PDCCHs are divided based on multicast and broadcast, the LP-WUS separately indicates a PDCCH indicating multicast scheduling and a PDCCH indicating broadcast scheduling. In the case where the second PDCCHs are divided based on RNTI, the LP-WUS separately indicates PDCCHs indicating multicast and/or broadcast scheduling and scrambled by different RNTIs.

In an example, the second PDCCH indicated by the LP-WUS includes: a PDCCH indicating multicast scheduling and/or a PDCCH indicating broadcast scheduling, and the terminal device resumes the monitoring, by the MR, of the PDCCH indicating multicast scheduling and/or the PDCCH indicating broadcast scheduling.

In an example, the second PDCCH indicated by the LP-WUS includes a PDCCH indicating multicast or broadcast scheduling and scrambled by one or more RNTI1, and the terminal device resumes the monitoring, by the MR, of the PDCCH indicating multicast or broadcast scheduling and scrambled by the one or more RNTI1.

In an example, the second PDCCH indicated by the LP-WUS includes: a PDCCH indicating multicast scheduling and a PDCCH indicating broadcast scheduling and scrambled by one or more RNTI, and the terminal device resumes the monitoring, by the MR, of the PDCCH indicating multicast scheduling and the PDCCH indicating broadcast scheduling and scrambled by the one or more RNTI.

In an example, the second PDCCH indicated by the LP-WUS includes: a PDCCH indicating broadcast scheduling and a PDCCH indicating multicast scheduling and scrambled by one or more RNTI1, and the terminal device resumes the monitoring, by the MR, of the PDCCH indicating broadcast scheduling and the PDCCH indicating multicast scheduling and scrambled by the one or more RNTI1.

In the embodiments of the present disclosure, in the case of controlling the monitoring of a PDCCH indicating unicast scheduling and a PDCCH indicating multicast and/or broadcast scheduling through one or more LP-WUSs, different PDCCHs may be controlled through the same LP-WUS, or each PDCCH may be separately controlled through a different LP-WUS, thereby improving the flexibility of PDCCH monitoring control.

In some embodiments, if the LP-WUS is used for controlling the monitoring, by the MR, of the first PDCCH and the second PDCCH, or the LP-WUS is used for controlling the monitoring, by the MR, of the first PDCCH and/or the second PDCCH indicated by the LP-WUS, the terminal device further executes the following.

The terminal device receives first configuration information configured by the network device, where the first configuration information is used for monitoring of the LP-WUS.

In monitoring-control manner 1 or monitoring-control manner 2, the monitoring of the first PDCCH and the second PDCCH is controlled using the same LP-WUS. The network device configures first configuration information for the terminal device, and the first configuration information is used for monitoring of the LP-WUS. Then, the terminal device monitors the LP-WUS based on the first configuration information.

Optionally, the first configuration information may include: LP-WUS monitoring resource configuration.

In some embodiments, the LP-WUS is used for controlling monitoring, by the MR, of a target PDCCH corresponding to the LP-WUS, where the target PDCCH is the first PDCCH or the second PDCCH.

Here, the manner in which the LP-WUS controls the monitoring of the first PDCCH and the second PDCCH is monitoring-control manner 3: different LP-WUSs are used for the monitoring of the corresponding first PDCCH or second PDCCH.

In monitoring-control manner 3, the PDCCH corresponding to the LP-WUS received by the terminal device is called a target PDCCH, where the target PDCCH is or belongs to the first PDCCH or the second PDCCH.

In an example, the LP-WUS corresponds to the first PDCCH, and this LP-WUS is used for controlling the monitoring, by the MR, of the first PDCCH. In this case, the monitoring scenario is monitoring scenario 1.

In an example, the LP-WUS corresponds to the second PDCCH, and this LP-WUS is used for controlling the monitoring, by the MR, of the second PDCCH. In this case, the monitoring scenario is monitoring scenario 2.

The first PDCCH and the second PDCCH are corresponding to different LP-WUSs respectively. It can be understood that, the monitoring of the first PDCCH and the second PDCCH are respectively controlled by the LP-WUSs corresponding to the PDCCHs, and each LP-WUS is used for controlling the monitoring of the corresponding PDCCH.

In the embodiments of the present disclosure, the PDCCH corresponding to the LP-WUS may be understood as the PDCCH associated with the LP-WUS, and the terminal device may establish an association relationship between the LP-WUS and the PDCCH.

In embodiments of the present disclosure, the terminal device may determine the target PDCCH corresponding to the received LP-WUS based on a resource of the received LP-WUS or an LP-WUS sequence. In other embodiments, indication information indicating the target PDCCH may be carried in the received LP-WUS, for example: an RNTI scrambling the target PDCCH, a channel identifier identifying the target PDCCH, etc.

For monitoring-control manner 3, the LP-WUS received by the terminal device is used for controlling one PDCCH.

In some embodiments, the LP-WUS is one of multiple LP-WUSs. The multiple LP-WUSs include:
a first LP-WUS, used for controlling the monitoring, by the MR, of the first PDCCH; and
one or more second LP-WUSs, used for controlling the monitoring, by the MR, of the second PDCCH(s).

In embodiments of the present disclosure, the first LP-WUS corresponds to the first PDCCH and is used for controlling the monitoring, by the MR, of the first PDCCH. The second LP-WUS corresponds to the second PDCCH and is used for controlling the monitoring, by the MR, of the second PDCCH. There are one or more second LP-WUSs. Different second LP-WUSs are used for controlling the monitoring, by the MR, of different second PDCCHs.

In some embodiments, different second LP-WUSs among the multiple second LP-WUSs are used for:
controlling the monitoring of a PDCCH indicating multicast scheduling or a PDCCH indicating broadcast scheduling; or,
controlling the monitoring of PDCCHs indicating multicast or broadcast scheduling and scrambled by different RNTIs.

In the embodiments of the present disclosure, different second PDCCHs may be divided based on multicast and broadcast and/or divided based on different RNTIs. In the case where the second PDCCHs are divided based on multicast and broadcast, the LP-WUS separately indicates a PDCCH indicating multicast scheduling and a PDCCH indicating broadcast scheduling. In the case where the second PDCCHs are divided based on RNTIs, the LP-WUS separately indicates PDCCHs indicating multicast and/or broadcast scheduling and scrambled by different RNTIs.

The second LP-WUS may be an LP-WUS corresponding to a second PDCCH divided based on multicast or broadcast, and this second LP-WUS is used for controlling the monitoring of a PDCCH indicating multicast scheduling or a PDCCH indicating broadcast scheduling.

In an example, the second LP-WUS received by the terminal device is used for controlling the monitoring of a PDCCH indicating multicast scheduling, and the terminal device controls the monitoring of the PDCCH indicating multicast scheduling based on this second LP-WUS.

In an example, the second LP-WUS received by the terminal device is used for controlling the monitoring of a PDCCH indicating broadcast scheduling, and the terminal device controls the monitoring of the PDCCH indicating broadcast scheduling based on this second LP-WUS.

The second LP-WUS may be an LP-WUS corresponding to a second PDCCH divided based on RNTI, and the second LP-WUS is used for controlling the monitoring of a PDCCH scrambled by an RNTI and indicating multicast or broadcast scheduling.

In an example, the second LP-WUS received by the terminal device is used for controlling the monitoring of a PDCCH indicating multicast/broadcast scheduling and scrambled by a first RNTI, and the terminal device controls, based on this second LP-WUS, the monitoring of the PDCCH indicating multicast/broadcast scheduling and scrambled by the first RNTI.

In an example, the second LP-WUS received by the terminal device is used for controlling the monitoring of a PDCCH indicating multicast/broadcast scheduling and scrambled by a second RNTI, and the terminal device controls, based on this second LP-WUS, the monitoring of the PDCCH indicating multicast/broadcast scheduling scrambled by the second RNTI.

In some embodiments, the LP-WUS indicating wake-up is used for waking up the monitoring, by the MR, of the target PDCCH corresponding to the LP-WUS.

In the embodiments of the present disclosure, the LP-WUS may indicate wake-up or may not indicate wake-up. The LP-WUS indicating wake-up further indicates the first PDCCH or the second PDCCH, and this LP-WUS is used for waking up the monitoring, by the MR, of the first PDCCH or the second PDCCH corresponding to this LP-WUS.

In some embodiments, the terminal device further implements the following.

Based on the LP-WUS indicating wake-up, the terminal device resumes the monitoring, by the MR, of the target PDCCH.

When the LR of the terminal device receives the LP-WUS indicating wake-up, the LR transmits a wake-up indication to the MR, and the MR resumes the monitoring of the first PDCCH or the second PDCCH corresponding to the LP-WUS based on the wake-up indication.

Based on different PDCCHs corresponding to the LP-WUSs, the wake-up of the MR has the following situations:

Situation 4: if the LP-WUS is a first LP-WUS corresponding to the first PDCCH, based on the first LP-WUS indicating wake-up, the terminal device resumes the monitoring, by the MR, of the first PDCCH.

Situation 5: if the LP-WUS is a second LP-WUS corresponding to the second PDCCH, based on the second LP-WUS indicating wake-up, the terminal device resumes the monitoring, by the MR, of the second PDCCH.

For situation 4, the LP-WUS received by the terminal device is a first LP-WUS corresponding to the first PDCCH, and the MR resumes the monitoring of the first PDCCH based on the wake-up indication.

After the MR of the terminal device resumes the monitoring of the first PDCCH, the terminal device is able to monitor the first PDCCH through the MR.

The terminal device being able to monitor the first PDCCH through the MR may be understood as the terminal device being able to monitor the first PDCCH based on a certain mechanism (such as the DRX mechanism).

Optionally, the terminal device monitors the first PDCCH during an active time of unicast DRX.

In some embodiments, the monitoring state of the second PDCCH remains unchanged.

If the terminal device receives the first LP-WUS, the terminal device maintains the monitoring state of the second PDCCH unchanged.

For situation 5, the LP-WUS received by the terminal device is a second LP-WUS corresponding to the second PDCCH, and the MR resumes the monitoring of the second PDCCH based on the wake-up indication.

After the MR of the terminal device resumes the monitoring of the second PDCCH, the terminal device is able to monitor the second PDCCH through the MR.

The terminal device being able to monitor the second PDCCH through the MR may be understood as the terminal device being able to monitor the second PDCCH based on a certain mechanism (such as the DRX mechanism).

Optionally, the terminal device monitors the second PDCCH during an active time of broadcast or multicast DRX.

In some embodiments, the monitoring state of the first PDCCH remains unchanged.

If the terminal device receives the second LP-WUS, the terminal device maintains the monitoring state of the first PDCCH unchanged.

Optionally, if the second PDCCH corresponding to the second LP-WUS is a PDCCH indicating multicast scheduling, the monitoring state of a PDCCH indicating broadcast scheduling remains unchanged.

When the second LP-WUS received by the terminal device corresponds to a PDCCH indicating multicast scheduling, the terminal device resumes the monitoring, by the MR, of the PDCCH indicating multicast scheduling, and maintains the monitoring state of a PDCCH indicating broadcast scheduling unchanged.

Optionally, if the second PDCCH corresponding to the second LP-WUS is a PDCCH indicating broadcast scheduling, the monitoring state of a PDCCH indicating multicast scheduling remains unchanged.

When the second LP-WUS received by the terminal device corresponds to a PDCCH indicating broadcast scheduling, the terminal device resumes the monitoring, by the MR, of the PDCCH indicating broadcast scheduling, and maintains the monitoring state of a PDCCH indicating multicast scheduling unchanged.

Optionally, if the second PDCCH corresponding to the second LP-WUS is a PDCCH indicating multicast or broadcast scheduling and scrambled by a first RNTI, the monitoring state of a PDCCH indicating multicast or broadcast scheduling and scrambled by a second RNTI remains unchanged.

When the second LP-WUS received by the terminal device is an LP-WUS corresponding to a second PDCCH divided based on RNTI, and the currently received second LP-WUS corresponds to a PDCCH indicating multicast or broadcast scheduling and scrambled by a first RNTI, the terminal device resumes the monitoring, by the MR, of the PDCCH indicating multicast or broadcast scheduling and scrambled by the first RNTI, and maintains the monitoring state of the PDCCH indicating multicast or broadcast scheduling and scrambled by a second RNTI unchanged.

It can be understood that the first RNTI and the second RNTI are two different RNTIs used for scrambling PDCCHs indicating multicast or broadcast scheduling. The first RNTI is the RNTI scrambling the PDCCH corresponding to the second LP-WUS received by the terminal device, and the second RNTI is any RNTI other than the first RNTI.

In some embodiments, the LP-WUS used for indicating wake-up is further used for controlling the MR to enter a wake-up state from a sleep state, where the MR performs monitoring of the target PDCCH corresponding to the LP-WUS in the wake-up state.

When the LR of the terminal device receives the LP-WUS indicating wake-up, the LR transmits a wake-up indication to the MR. The MR enters the wake-up state from the sleep state based on the received wake-up indication, and resumes the monitoring of the target PDCCH corresponding to the LP-WUS in the wake-up state, i.e., while being in the wake-up state.

In embodiments of the present disclosure, by using different LP-WUSs to separately control the monitoring of a PDCCH indicating unicast scheduling and a PDCCH indicating multicast and/or broadcast scheduling, the control of the monitoring of different PDCCHs is independent of each other, thereby improving the flexibility of PDCCH monitoring control.

In some embodiments, the terminal device does not monitor the first PDCCH and/or the second PDCCH when the MR is in the sleep state.

In some embodiments, if the LP-WUS is used for controlling the monitoring, by the MR, of the target PDCCH corresponding to the LP-WUS, the terminal device further executes the following.

The terminal device receives multiple second configuration information configured by the network device, where the multiple second configuration information are used for monitoring of multiple LP-WUSs.

In monitoring-control manner 3, the monitoring of the first PDCCH and the monitoring of the second PDCCH are controlled using different LP-WUSs, and different second PDCCHs are controlled using different LP-WUSs. The network device configures multiple second configuration information for the terminal device, and different second configuration information are used for monitoring of LP-WUSs corresponding to different PDCCHs. Then, the terminal device monitors each LP-WUS corresponding to each PDCCH based on the multiple second configuration information. The different PDCCHs here may be understood as the first PDCCH and the second PDCCH, or different second PDCCHs.

Optionally, the second configuration information may include one or more of the following: LP-WUS monitoring resource configuration, LP-WUS sequence (LP-WUS code). The second configuration information may also be used for the terminal device to identify different LP-WUSs.

In some embodiments, a manner of resuming the monitoring, by the MR, of the first PDCCH includes at least one of the following:

Resumption manner 1: starting a DRX on-duration timer corresponding to unicast DRX.

Resumption manner 2: monitoring a wake-up signal after receiving the LP-WUS used for resuming the monitoring of the first PDCCH, and starting a DRX on-duration timer corresponding to unicast DRX when the wake-up signal is detected.

Resumption manner 3: starting a first timer corresponding to unicast DRX, where during running of the first timer, the terminal device is in an active time of unicast DRX.

Resumption manner 4: entering an active time of unicast DRX.

In resumption manner 1, the terminal device waits for the start time of a DRX on-duration timer (drx-onDurationTimer) based on a unicast DRX parameter, and starts the drx-onDurationTimer at the start time to enter an active time of unicast DRX.

In resumption manner 2, the terminal device monitors a wake-up signal (WUS), also called a DCI with CRC scrambled by PS-RNTI (DCP) signal, and determines whether to start a DRX on-duration timer corresponding to unicast DRX based on the reception status of the WUS.

In resumption manner 3, a first timer is set, and during the running time of the first timer, the unicast DRX of the terminal device is in an active time. The first timer may be a timer already defined in the protocol, such as drx-InactivityTimer, or may be a custom timer.

In resumption manner 4, the terminal device directly enters an active time of unicast DRX.

In some embodiments, a manner of resuming the monitoring, by the MR, of the second PDCCH include one of the following:

Resumption manner 5: starting a DRX on-duration timer corresponding to multicast or broadcast DRX.

Resumption manner 6: starting a second timer corresponding to multicast or broadcast DRX, where during running of the second timer, the terminal device is in an active time of multicast or broadcast DRX.

Resumption manner 7: entering an active time of multicast or broadcast DRX.

In resumption manner 5, the terminal device waits for the start time of a PTM DRX on-duration timer (drx-onDurationTimerPTM) based on a multicast or broadcast DRX parameter, and starts the drx-onDurationTimerPTM at the start time to enter an active time of multicast or broadcast DRX.

In resumption manner 6, a second timer is set, and during the running time of the second timer, the multicast or broadcast DRX of the terminal device is in an active time. The second timer may be a timer already defined in the protocol, such as drx-InactivityTimerPTM, or may be a custom timer.

In resumption manner 7, the terminal device directly enters an active time of multicast or broadcast DRX.

In some embodiments, the LP-WUS is used to control the monitoring, by the MR of the terminal device, of the first PDCCH and/or the second PDCCH to be performed after a first time offset of a first time, the first time being a receiving time of the LP-WUS.

The terminal device controls the monitoring, by the MR, of the first PDCCH and/or the second PDCCH based on the received LP-WUS after a first time offset following the reception of the LP-WUS.

Embodiments of the present disclosure provide a wireless communication method applied to a network device. As illustrated in FIG. 8, the method includes the following.

S801: A network device transmits an LP-WUS to a terminal device, where the LP-WUS is used for controlling transmission of a first PDCCH and/or a second PDCCH to the terminal device, the first PDCCH is a PDCCH indicating unicast scheduling, and the second PDCCH is a PDCCH indicating multicast and/or broadcast scheduling.

The network device transmits the LP-WUS to the terminal device in a connected state, so as to control the monitoring, by an MR of the terminal device, of the first PDCCH and/or the second PDCCH through the transmitted LP-WUS, and also to control the transmission, by the network device, of the first PDCCH and/or the second PDCCH. The first PDCCH is used for indicating unicast scheduling, and the second PDCCH is used for indicating multicast and/or broadcast scheduling.

The first PDCCH indicating unicast scheduling may be understood as the first PDCCH being transmitted to the terminal device for indicating a first PDSCH or a first PUSCH of a unicast service, or for scheduling the first PDSCH or the first PUSCH of the unicast service. The second PDCCH indicating multicast and/or broadcast scheduling may be understood as the second PDCCH being transmitted to the terminal device for indicating a second PDSCH of a multicast and/or broadcast service, or being transmitted to the terminal device for scheduling the second PDSCH of the multicast and/or broadcast service.

In the embodiments of the present disclosure, the LP-WUS being used for controlling transmission of the first PDCCH and/or the second PDCCH includes one or more of the following transmission scenarios:

Transmission scenario 1: controlling the transmission of the first PDCCH.

Transmission scenario 2: controlling the transmission of the second PDCCH.

Transmission scenario 3: controlling the transmission of the first PDCCH and controlling the transmission of the second PDCCH.

In transmission scenario 1, the LP-WUS is used for resuming the transmission of the first PDCCH, or maintaining the non-transmission of the first PDCCH, or maintaining the transmission of the first PDCCH.

In transmission scenario 2, the LP-WUS is used for resuming the transmission of the second PDCCH, or maintaining the non-transmission of the second PDCCH, or maintaining the transmission of the second PDCCH.

In transmission scenario 3, the LP-WUS is used for simultaneously controlling the transmission of the first PDCCH and the transmission of the second PDCCH, where the control of the transmission of the first PDCCH by the LP-WUS may refer to transmission scenario 1, and the control of the transmission of the second PDCCH by the LP-WUS may refer to transmission scenario 2.

In embodiments of the present disclosure, when the network device transmits the LP-WUS to the terminal device, based on the transmitted LP-WUS, the transmission of a PDCCH indicating unicast scheduling and/or a PDCCH indicating multicast and/or broadcast scheduling is controlled, enabling the network device to transmit the LP-WUS according to service transmission requirements of unicast and multicast/broadcast.

The wireless communication method illustrated in FIG. 8 provided by the embodiments of the present disclosure is further described below.

In some embodiments, the LP-WUS is used for controlling transmission of the first PDCCH and the second PDCCH.

Here, a manner in which the LP-WUS controls the transmission of the first PDCCH and the second PDCCH is transmission-control manner 1: the LP-WUS simultaneously controls the first PDCCH and the second PDCCH. The LP-WUS transmitted by the network device is used for controlling both the first PDCCH and the second PDCCH.

In transmission-control manner 1, the transmission states (also called transmission behaviors) of the first PDCCH and the second PDCCH are controlled using the same LP-WUS. It can be understood that the LP-WUS is intended for the first PDCCH and the second PDCCH by default.

Under transmission-control manner 1, a scenario in which the LP-WUS is used for transmission of the first PDCCH and/or the second PDCCH only include transmission scenario 1.

The network device controls the transmission of the first PDCCH and the second PDCCH based on the transmitted LP-WUS.

In some embodiments, the LP-WUS indicating wake-up is used for indicating resumption of transmission of the first PDCCH and the second PDCCH.

In embodiments of the present disclosure, the LP-WUS may indicate wake-up or may not indicate wake-up. The LP-WUS indicating wake-up is used for waking up the monitoring, by the MR, of the first PDCCH and the second PDCCH.

Optionally, the network device transmits the LP-WUS not indicating wake-up, and maintains or keeps the transmission states of the first PDCCH and the second PDCCH unchanged.

In some embodiments, the network device further implements the following.

Based on the LP-WUS indicating wake-up, the network device resuming transmission of the first PDCCH and the second PDCCH.

The network device simultaneously resumes transmission of the first PDCCH and the second PDCCH based on the transmitted LP-WUS.

After the network device resumes transmission of the first PDCCH and the second PDCCH, the network device is able to transmit the first PDCCH and the second PDCCH.

The network device being able to transmit the first PDCCH and the second PDCCH may be understood as the network device being able to transmit the first PDCCH and the second PDCCH based on a certain mechanism (such as the DRX mechanism), but this does not mean that the first PDCCH and the second PDCCH are continuously transmitted.

Optionally, the network device monitors the first PDCCH during an active time of unicast DRX, and monitors the second PDCCH during an active time of multicast or broadcast DRX.

In some embodiments, the network device does not transmit the first PDCCH and the second PDCCH to the terminal device before resuming transmission of the first PDCCH and the second PDCCH.

Before the network device transmits the LP-WUS, the first PDCCH and the second PDCCH are not transmitted. When the network device transmits the LP-WUS indicating wake-up, transmission of the first PDCCH and the second PDCCH is resumed based on the transmitted LP-WUS indicating wake-up.

In embodiments of the present disclosure, using the same LP-WUS to simultaneously control the transmission of a PDCCH indicating unicast scheduling and a PDCCH indicating multicast and/or broadcast scheduling, thereby controlling the monitoring of different PDCCHs by the terminal device through the same LP-WUS, minimizes signaling overhead.

In some embodiments, the LP-WUS is used for controlling transmission of the first PDCCH and/or the second PDCCH indicated by the LP-WUS.

Here, the manner in which the LP-WUS controls the transmission of the first PDCCH and the second PDCCH is transmission control manner 2: the LP-WUS is used for controlling transmission of the first PDCCH and/or the second PDCCH indicated by the LP-WUS itself.

In transmission control manner 2, the LP-WUS may indicate one or two of the first PDCCH and the second PDCCH, and the LP-WUS is used for controlling transmission of the PDCCH indicated by this LP-WUS.

In an example, the LP-WUS indicates the first PDCCH, and the LP-WUS is used for controlling transmission of the first PDCCH. In this case, the transmission scenario is transmission scenario 1.

In an example, the LP-WUS indicates the second PDCCH, and the LP-WUS is used for controlling transmission of the second PDCCH. In this case, the transmission scenario is transmission scenario 2.

In an example, the LP-WUS indicates the first PDCCH and the second PDCCH, and the LP-WUS is used for controlling transmission of the first PDCCH and the second PDCCH. In this case, the transmission scenario is transmission scenario 3.

In embodiments of the present disclosure, a manner in which the LP-WUS indicates the first PDCCH and/or the second PDCCH may include but is not limited to:
the LP-WUS carries an RNTI of the indicated first PDCCH and/or an RNTI of the indicated second PDCCH;
the LP-WUS carries a service identifier corresponding to the indicated first PDCCH and/or a service identifier corresponding to the indicated second PDCCH.

For transmission control manner 2, the transmission states of the first PDCCH and the second PDCCH are controlled using the same LP-WUS. It can be understood that the LP-WUS is intended for the indicated first PDCCH and/or the indicated second PDCCH. The LP-WUS transmitted by the network device can be used for controlling transmission of the first PDCCH and/or the second PDCCH, where the PDCCH for which the LP-WUS is intended is the PDCCH indicated by the LP-WUS.

In some embodiments, the LP-WUS indicating wake-up is used for resuming transmission of the first PDCCH and/or the second PDCCH indicated by the LP-WUS.

In embodiments of the present disclosure, the LP-WUS may indicate wake-up or may not indicate wake-up. The LP-WUS indicating wake-up is further used for indicating the first PDCCH and/or the second PDCCH, and the LP-WUS is used for waking up the monitoring, by the MR, of the first PDCCH and/or the second PDCCH indicated by the LP-WUS.

Optionally, the network device transmits the LP-WUS not indicating wake-up, and maintains the transmission states of the first PDCCH and/or the second PDCCH unchanged.

In some embodiments, the network device further implements the following.

Based on the LP-WUS indicating wake-up, the network device resumes transmission of the first PDCCH and/or the second PDCCH indicated by the LP-WUS.

Based on different PDCCHs indicated by the LP-WUS, the resumption of the network device includes the following situations.

Resumption situation 1: if the LP-WUS indicates the first PDCCH, based on the LP-WUS indicating wake-up, the network device resumes transmission of the first PDCCH.

Resumption situation 2: if the LP-WUS indicates the second PDCCH, based on the LP-WUS indicating wake-up, the network device resumes transmission of the second PDCCH.

Resumption situation 3: if the LP-WUS indicates the first PDCCH and the second PDCCH, based on the LP-WUS indicating wake-up, the network device resumes transmission of the first PDCCH and the second PDCCH.

For resumption situation 1, the LP-WUS indicates the first PDCCH, and the network device resumes transmission of the first PDCCH based on the LP-WUS.

After the network device resumes transmission of the first PDCCH, the network device is able to transmit the first PDCCH.

The network device being able to transmit the first PDCCH may be understood as the network device being able to transmit the first PDCCH based on a certain mechanism (such as the DRX mechanism), but this does not mean that the first PDCCH is continuously transmitted.

Optionally, the network device transmits the first PDCCH during an active time of unicast DRX.

In some embodiments, the transmission state of the second PDCCH remains unchanged.

If the LP-WUS transmitted by the network device indicates the first PDCCH, it can be understood that the LP-WUS does not indicate the second PDCCH, and this LP-WUS is not intended for controlling the second PDCCH. The network device maintains the transmission state of the second PDCCH unchanged.

In an example, before the network device transmits the LP-WUS, the transmission state of the second PDCCH is transmission. After transmitting the LP-WUS, the network device resumes transmission of the first PDCCH and maintains transmission of the second PDCCH.

In an example, before the network device transmits the LP-WUS, the transmission state of the second PDCCH is non-transmission. After transmitting the LP-WUS, the network device resumes transmission of the first PDCCH and maintains non-transmission of the second PDCCH.

For resumption situation 2, the LP-WUS indicates the second PDCCH, and the network device resumes transmission of the second PDCCH based on the LP-WUS.

After the network device resumes transmission of the second PDCCH, the network device is able to transmit the second PDCCH.

The network device being able to transmit the second PDCCH may be understood as the network device being able to transmit the second PDCCH based on a certain mechanism (such as the DRX mechanism), but this does not mean that the second PDCCH is continuously transmitted.

Optionally, the network device transmits the second PDCCH during an active time of multicast or broadcast DRX.

In some embodiments, the transmission state of the first PDCCH remains unchanged.

If the LP-WUS transmitted by the network device indicates the second PDCCH, it can be understood that the LP-WUS does not indicate the first PDCCH, and this LP-WUS is not intended for controlling the first PDCCH. The network device maintains the transmission state of the first PDCCH unchanged.

In an example, before the network device transmits the LP-WUS, the transmission state of the first PDCCH is transmission. After transmitting the LP-WUS, the network device resumes transmission of the second PDCCH and maintains transmission of the first PDCCH.

In an example, before the network device transmits the LP-WUS, the transmission state of the first PDCCH is non-transmission. After transmitting the LP-WUS, the network device resumes transmission of the second PDCCH and maintains non-transmission of the first PDCCH.

For resumption situation 3, the LP-WUS indicates the first PDCCH and the second PDCCH, and the network device resumes transmission of the first PDCCH and the second PDCCH based on the LP-WUS.

After the network device resumes transmission of the first PDCCH and the second PDCCH, the network device is able to transmit the first PDCCH and the second PDCCH.

The network device being able to transmit the first PDCCH and the second PDCCH may be understood as the network device being able to transmit the first PDCCH and the second PDCCH based on a certain mechanism (such as the DRX mechanism), but this does not mean that the first PDCCH and the second PDCCH are continuously transmitted.

Optionally, the network device transmits the first PDCCH during an active time of unicast DRX, and transmits the second PDCCH during an active time of multicast or broadcast DRX.

In some embodiments, the network device does not transmit the first PDCCH and/or the second PDCCH before resuming transmission of the first PDCCH and/or the second PDCCH.

Before the network device transmits the LP-WUS indicating wake-up, the first PDCCH and/or the second PDCCH are not transmitted. When the network device transmits the LP-WUS indicating wake-up, transmission of the first PDCCH and/or the second PDCCH indicated by the LP-WUS is resumed based on the transmitted LP-WUS indicating wake-up.

In embodiments of the present disclosure, the behaviors of the network device include the following situations:

Transmission situation 1: not transmitting the first PDCCH, not transmitting the second PDCCH;

Transmission situation 2: not transmitting the first PDCCH, transmitting the second PDCCH;

Transmission situation 3: transmitting the first PDCCH, not transmitting the second PDCCH.

In some embodiments, if the LP-WUS indicates the second PDCCH, the LP-WUS indicates one or more of the following:
a PDCCH indicating multicast scheduling and/or a PDCCH indicating broadcast scheduling; and
a PDCCH indicating multicast or broadcast scheduling and scrambled by a RNTI.

In embodiments of the present disclosure, different second PDCCHs are divided based on multicast and broadcast and/or divided based on different RNTIs. In the case where the second PDCCHs are divided based on multicast and broadcast, the LP-WUS separately indicates a PDCCH indicating multicast scheduling and a PDCCH indicating broadcast scheduling. In the case where the second PDCCHs are divided based on RNTI, the LP-WUS separately indicates PDCCHs indicating multicast and/or broadcast scheduling and scrambled by different RNTIs.

In an example, the second PDCCH indicated by the LP-WUS includes: a PDCCH indicating multicast scheduling and/or a PDCCH indicating broadcast scheduling, and the network device resumes transmission of the PDCCH indicating multicast scheduling and/or the PDCCH indicating broadcast scheduling.

In an example, the second PDCCH indicated by the LP-WUS includes a PDCCH indicating multicast or broadcast scheduling scrambled by one or more RNTI1, and the network device resumes transmission of the PDCCH indicating multicast or broadcast scheduling and scrambled by the one or more RNTI1.

In an example, the second PDCCH indicated by the LP-WUS includes: a PDCCH indicating multicast scheduling and a PDCCH indicating broadcast scheduling and scrambled by one or more RNTI, and the network device resumes transmission of the PDCCH indicating multicast scheduling and the PDCCH indicating broadcast scheduling and scrambled by the one or more RNTI.

In an example, the second PDCCH indicated by the LP-WUS includes: a PDCCH indicating broadcast scheduling and a PDCCH indicating multicast scheduling and scrambled by one or more RNTI1, and the network device resumes transmission of the PDCCH indicating broadcast scheduling and the PDCCH indicating multicast scheduling and scrambled by the one or more RNTI1.

In embodiments of the present disclosure, in the case of controlling the monitoring or transmission of a PDCCH indicating unicast scheduling and a PDCCH indicating multicast and/or broadcast scheduling through one or more LP-WUSs, different PDCCHs may be controlled through the same LP-WUS, or each PDCCH may be separately controlled through a different LP-WUS, thereby improving the flexibility of PDCCH monitoring or transmission control.

In some embodiments, if the LP-WUS is used for controlling transmission of the first PDCCH and the second PDCCH, or the LP-WUS is used for controlling transmission of the first PDCCH and/or the second PDCCH indicated by the LP-WUS, the network device further executes the following.

The network device configures first configuration information for the terminal device, where the first configuration information is used for monitoring of the LP-WUS.

In transmission control manner 1 or transmission control manner 2, transmission of the first PDCCH and the second PDCCH is controlled using the same LP-WUS. The network device configures the first configuration information for the terminal device, and the first configuration information is used for monitoring of the LP-WUS. Then, the terminal device monitors the LP-WUS based on the first configuration information.

Optionally, the first configuration information may include: LP-WUS monitoring resource configuration.

In some embodiments, the LP-WUS is used for controlling transmission of a target PDCCH corresponding to the LP-WUS, where the target PDCCH is the first PDCCH or the second PDCCH.

Here, the manner in which the LP-WUS controls the transmission of the first PDCCH and the second PDCCH is transmission control manner 3: different LP-WUSs are used for transmission of the corresponding first PDCCH or second PDCCH.

In transmission control manner 3, the PDCCH corresponding to the LP-WUS transmitted by the network device is called a target PDCCH, where the target PDCCH is or belongs to the first PDCCH or the second PDCCH.

In an example, the LP-WUS corresponds to the first PDCCH, and this LP-WUS is used for controlling transmission of the first PDCCH. In this case, the transmission scenario is transmission scenario 1.

In an example, the LP-WUS corresponds to the second PDCCH, and this LP-WUS is used for controlling transmission of the second PDCCH. In this case, the transmission scenario is transmission scenario 2.

The first PDCCH and the second PDCCH are corresponding to different LP-WUSs respectively. It can be understood that, the transmission of the first PDCCH and the second PDCCH are respectively controlled by the LP-WUSs corresponding to the PDCCHs, and each LP-WUS is used for controlling transmission of the corresponding PDCCH.

In embodiments of the present disclosure, the network device may determine the target PDCCH corresponding to the transmitted LP-WUS based on the resource of the transmitted LP-WUS or an LP-WUS sequence, or may carry, in the transmitted LP-WUS, indication information indicating the target PDCCH, for example: an RNTI scrambling the target PDCCH, a channel identifier identifying the target PDCCH, etc.

For transmission control manner 3, the LP-WUS transmitted by the network device is used for controlling one PDCCH.

In some embodiments, the LP-WUS is one of multiple LP-WUSs. The multiple LP-WUSs include:
a first LP-WUS, used for controlling transmission of the first PDCCH; and
one or more second LP-WUSs, used for controlling transmission of the second PDCCH(s).

In some embodiments, different second LP-WUSs among the multiple second LP-WUSs are used for:
controlling transmission of a PDCCH indicating multicast scheduling or a PDCCH indicating broadcast scheduling; or,
controlling transmission of PDCCHs indicating multicast or broadcast scheduling and scrambled by different RNTIs.

In the embodiments of the present disclosure, different second PDCCHs may be divided based on multicast and broadcast and/or divided based on different RNTIs. In the case where the second PDCCHs are divided based on multicast and broadcast, the LP-WUS separately indicates a PDCCH indicating multicast scheduling and a PDCCH indicating broadcast scheduling. In the case where the second PDCCHs are divided based on RNTIs, the LP-WUS separately indicates PDCCHs indicating multicast and/or broadcast scheduling and scrambled by different RNTIs.

The second LP-WUS may be an LP-WUS corresponding to a second PDCCH divided based on multicast or broadcast, and this second LP-WUS is used for controlling the transmission of a PDCCH indicating multicast scheduling or a PDCCH indicating broadcast scheduling.

In an example, the second LP-WUS transmitted by the network device is used for controlling transmission of a PDCCH indicating multicast scheduling, and the network device controls transmission of the PDCCH indicating multicast scheduling based on the second LP-WUS.

In an example, the second LP-WUS transmitted by the network device is used for controlling transmission of a PDCCH indicating broadcast scheduling, and the network device controls transmission of the PDCCH indicating broadcast scheduling based on the second LP-WUS.

The second LP-WUS may be an LP-WUS corresponding to a second PDCCH divided based on RNTI, and the second LP-WUS is used for controlling the transmission of the PDCCH scrambled by an RNTI and indicating multicast or broadcast scheduling.

In an example, the second LP-WUS transmitted by the network device is used for controlling transmission of a PDCCH indicating multicast/broadcast scheduling and scrambled by a first RNTI, and the network device controls transmission of the PDCCH indicating multicast/broadcast scheduling and scrambled by the first RNTI based on the second LP-WUS.

In an example, the second LP-WUS transmitted by the network device is used for controlling transmission of a PDCCH indicating multicast/broadcast scheduling and scrambled by a second RNTI, and the network device controls transmission of the PDCCH indicating multicast/broadcast scheduling and scrambled by the second RNTI based on the second LP-WUS.

In some embodiments, the LP-WUS indicating wake-up is used for resuming transmission of the target PDCCH corresponding to the LP-WUS.

In embodiments of the present disclosure, the LP-WUS may indicate wake-up or may not indicate wake-up. The LP-WUS indicating wake-up is further used for indicating the first PDCCH or the second PDCCH, and the LP-WUS is used for resuming the transmission of the first PDCCH or the second PDCCH corresponding to this LP-WUS.

In some embodiments, the network device further implements the following.

Based on the LP-WUS indicating wake-up, the network device resumes transmission of the target PDCCH.

Based on different PDCCHs corresponding to the LP-WUSs, the resumption of the network device has the following situations:

Resumption situation 4: if the LP-WUS is a first LP-WUS corresponding to the first PDCCH, based on the first LP-WUS indicating wake-up, the network device resumes transmission of the first PDCCH.

Resumption situation 5: if the LP-WUS is a second LP-WUS corresponding to the second PDCCH, based on the second LP-WUS indicating wake-up, the network device resumes transmission of the second PDCCH.

For resumption situation 4, the LP-WUS transmitted by the network device is the first LP-WUS corresponding to the first PDCCH, and the network device resumes transmission of the first PDCCH based on the LP-WUS.

After the network device resumes transmission of the first PDCCH, the first PDCCH can be transmitted.

In some embodiments, the transmission state of the second PDCCH remains unchanged.

For resumption situation 5, the LP-WUS transmitted by the network device is the second LP-WUS corresponding to the second PDCCH, and the network device resumes transmission of the second PDCCH based on the LP-WUS.

After the network device resumes transmission of the second PDCCH, the second PDCCH can be transmitted.

In some embodiments, the transmission state of the first PDCCH remains unchanged.

Optionally, if the second PDCCH corresponding to the second LP-WUS is a PDCCH indicating multicast scheduling, a transmission state of a PDCCH indicating broadcast scheduling remains unchanged.

When the second LP-WUS transmitted by the network device corresponds to a PDCCH indicating multicast scheduling, the network device resumes transmission of the PDCCH indicating multicast scheduling, and maintains the transmission state of a PDCCH indicating broadcast scheduling unchanged.

Optionally, if the second PDCCH corresponding to the second LP-WUS is a PDCCH indicating broadcast scheduling, a transmission state of a PDCCH indicating multicast scheduling remains unchanged.

When the second LP-WUS transmitted by the network device corresponds to a PDCCH indicating broadcast scheduling, the network device resumes transmission of the PDCCH indicating broadcast scheduling, and maintains the transmission state of a PDCCH indicating multicast scheduling unchanged.

Optionally, if the second PDCCH corresponding to the second LP-WUS is a PDCCH indicating multicast or broadcast scheduling and scrambled by a first RNTI, a transmission state of a PDCCH indicating multicast or broadcast scheduling and scrambled by a second RNTI remains unchanged.

When the second LP-WUS transmitted by the network device is an LP-WUS corresponding to a second PDCCH divided based on RNTI, and the currently transmitted second LP-WUS corresponds to a PDCCH indicating multicast or broadcast scheduling and scrambled by a first RNTI, the network device resumes transmission of the PDCCH indicating multicast or broadcast scheduling and scrambled by the first RNTI, and maintains the transmission state of a PDCCH indicating multicast or broadcast scheduling and scrambled by a second RNTI unchanged.

In some embodiments, the network device does not transmit the first PDCCH and/or the second PDCCH before resuming transmission of the target PDCCH.

In some embodiments, if the LP-WUS is used for controlling transmission of the target PDCCH corresponding to the LP-WUS, the network device further executes the following.

The network device configures multiple second configuration information for the terminal device, where the multiple second configuration information is used for monitoring of the multiple LP-WUSs.

In transmission control manner 3, transmission of the first PDCCH and transmission of the second PDCCH are controlled using different LP-WUSs, and different second PDCCHs are controlled using different LP-WUSs. The network device configures multiple second configuration information for the terminal device, and different second configuration information is used for monitoring of LP-WUSs corresponding to different PDCCHs. Then, the terminal device monitors the LP-WUSs respectively corresponding to the PDCCHs based on the multiple second configuration information. The different PDCCHs here may be understood as the first PDCCH and the second PDCCH, or different second PDCCHs.

Optionally, the second configuration information may include one or more of the following: LP-WUS monitoring resource configuration, and LP-WUS sequence (LP-WUS code). The second configuration information may also be used for the terminal device to identify different LP-WUSs.

In some embodiments, the execution of using the LP-WUS to control transmission of the first PDCCH and/or the second PDCCH to the terminal device is performed after a first time offset of a second time, where the second time is a time of transmitting the LP-WUS.

The network device controls transmission of the first PDCCH and/or the second PDCCH based on the transmitted LP-WUS after a first time offset following the transmission of the LP-WUS.

Embodiments of the present disclosure provide a wireless communication method which is applied to a wireless communication system including a terminal device and a network device. As illustrated in FIG. 9, the method includes the following.

S901: The network device transmits an LP-WUS to the terminal device.

S902: The network device controls transmission of a first PDCCH and/or a second PDCCH to the terminal device based on the LP-WUS.

S903: The terminal device controls monitoring of the first PDCCH and/or the second PDCCH based on the LP-WUS.

It should be noted that in FIG. 9, S902 precedes S903. In practical application, the execution order of S902 and S903 is not limited.

In the wireless communication method illustrated in FIG. 9, the implementation on the terminal device side may refer to the description of the wireless communication method on the terminal device side illustrated in FIG. 7, and the implementation on the network device side may refer to the description of the wireless communication method on the network device side illustrated in FIG. 8, which will not be repeated herein.

It can be understood that the network device transmits the LP-WUS to the terminal device. For the network device side, the LP-WUS is used for controlling transmission of the first PDCCH and/or the second PDCCH. For the terminal device side, the LP-WUS is used for controlling monitoring of the first PDCCH and/or the second PDCCH by the MR. However, the control manners for the first PDCCH and/or the second PDCCH are the same.

In the wireless communication methods illustrated in FIG. 7, FIG. 8, or FIG. 9, the following solutions are provided.

1. The terminal device uses the same LP-WUS to control the monitoring behaviors for a PDCCH indicating unicast scheduling and a PDCCH indicating multicast/broadcast scheduling. When the terminal device whose MR is in a sleep state receives the LP-WUS, the MR resumes the monitoring of the PDCCH indicating unicast scheduling and the PDCCH indicating multicast/broadcast scheduling.

2. The terminal device uses the same LP-WUS to control the monitoring behaviors for a PDCCH indicating unicast scheduling and a PDCCH indicating multicast/broadcast scheduling, where the LP-WUS indicates waking up the monitoring, by the MR, of the PDCCH indicating unicast scheduling and/or the PDCCH indicating multicast/broadcast scheduling.

3. The terminal device uses LP-WUSs respectively corresponding to a PDCCH indicating unicast scheduling and a PDCCH indicating multicast/broadcast scheduling to control the monitoring behaviors, where each LP-WUS indicates waking up the monitoring, by the MR, of a PDCCH indicating unicast scheduling or a PDCCH indicating multicast/broadcast scheduling.

The wireless communication method provided by the embodiments of the present disclosure is described below through multiple embodiments.

### Embodiment One

A UE in an RRC connected state uses the same LP-WUS to control the monitoring behaviors for a PDCCH indicating unicast scheduling and a PDCCH indicating multicast/broadcast scheduling. When the UE whose MR is in a sleep state receives the LP-WUS, the MR resumes the monitoring of the PDCCH indicating unicast scheduling and the PDCCH indicating multicast/broadcast scheduling.

The wireless communication method provided by this embodiment includes the following.

1. The UE in a connected state receives from a base station a set of LP-WUS configuration information, including LP-WUS monitoring resources, etc.;

2. The UE monitors the LP-WUS when the MR is in a sleep or light-sleep state, where the behaviors of the UE when the MR is in the sleep or light-sleep state include:
The UE does not monitor a PDCCH indicating unicast scheduling (such as a PDCCH scrambled by C-RNTI or CS-RNTI);
The UE does not monitor a PDCCH indicating multicast and/or broadcast scheduling (such as a PDCCH scrambled by G-RNTI or G-CS-RNTI).

3. After receiving the LP-WUS from the network, an LR of the UE transmits a wake-up indication to the MR, and the MR simultaneously resumes the monitoring of a PDCCH indicating unicast scheduling and the monitoring of a PDCCH indicating multicast and/or broadcast scheduling. The specific manner of resuming PDCCH monitoring may include but is not limited to one or more of the following.

For unicast DRX:
Manner 1: The UE starts a drx-onDurationTimer corresponding to DRX;
Manner 2: For DRX, in a case that the network device configures a DCP for the UE, the UE monitors the DCP and determines whether to start a corresponding drx-onDurationTimer based on the reception status of the DCP;
Manner 3: The UE starts a first timer corresponding to DRX. During operation of the first timer, the DRX is in a DRX Active Time. The first timer may be a drx-InactivityTimer or another timer;
Manner 4: The UE directly enters a DRX Active Time.

For multicast and/or broadcast DRX:

Manner 1: The UE starts a drx-onDurationTimerPTM corresponding to each multicast DRX and/or a drx-onDurationTimerPTM corresponding to each broadcast DRX;

Manner 2: The UE starts a second timer corresponding to each multicast DRX and/or each broadcast DRX. During operation of the second timer, the multicast or broadcast DRX is in an Active Time. The second timer may be a drx-InactivityTimerPTM corresponding to the multicast or broadcast DRX or another timer;

Manner 3: For each multicast and/or broadcast DRX, the UE directly enters a DRX Active Time;

Optionally, the UE executes the above operations after a first time offset following the reception of the LP-WUS.

### Embodiment Two

A UE in an RRC connected state uses the same LP-WUS to control the monitoring behaviors for a PDCCH indicating unicast scheduling and a PDCCH indicating multicast/broadcast scheduling, where the LP-WUS is used for indicating waking up the monitoring, by the MR, of the PDCCH indicating unicast scheduling and/or the PDCCH indicating multicast/broadcast scheduling.

The wireless communication method provided by this embodiment includes the following.

1. The UE in a connected state receives a set of LP-WUS configuration information from a base station, including LP-WUS monitoring resources, etc.;

2. The UE monitors the LP-WUS when the MR is in a sleep or light-sleep state, where the behaviors of the UE when the MR is in the sleep or light-sleep state include:
The UE does not monitor a PDCCH indicating unicast scheduling (such as a PDCCH scrambled by C-RNTI or CS-RNTI); and/or
The UE does not monitor a PDCCH indicating multicast and/or broadcast scheduling (such as a PDCCH scrambled by G-RNTI or G-CS-RNTI);

3. After receiving the LP-WUS from the network, an LR of the UE transmits a wake-up indication to the MR, and the MR resumes monitoring of the PDCCH indicating unicast scheduling and/or resumes monitoring of the PDCCH indicating multicast and/or broadcast scheduling according to the indication of the LP-WUS. Specifically, the following cases are included.

Case 1: If the LP-WUS indicates waking up the monitoring of the PDCCH indicating unicast scheduling, the MR resumes the monitoring of the PDCCH indicating unicast scheduling, and simultaneously maintains the monitoring state of the PDCCH indicating multicast and/or broadcast scheduling unchanged;

Case 2: If the LP-WUS indicates waking up the monitoring of the PDCCH indicating multicast and/or broadcast scheduling, the MR resumes the monitoring of the PDCCH indicating multicast and/or broadcast scheduling, and simultaneously maintains the monitoring state of the PDCCH indicating unicast scheduling unchanged;

Case 3: If the LP-WUS indicates waking up the monitoring of the PDCCH indicating unicast scheduling and the PDCCH indicating multicast and/or broadcast scheduling, the MR simultaneously resumes the monitoring of the PDCCH indicating unicast scheduling and the monitoring of the PDCCH indicating multicast and/or broadcast scheduling.

Optionally, for the monitoring state of a multicast and/or broadcast PDCCH, the LP-WUS may separately indicate for each multicast DRX and/or broadcast DRX (i.e., DRX corresponding to each G-RNTI or G-CS-CRNTI).

The specific manners of resuming PDCCH monitoring are the same as that in Embodiment One.

Optionally, the UE executes the above operations after a first time offset following the reception of the LP-WUS.

### Embodiment Three

A UE in an RRC connected state uses LP-WUSs respectively corresponding to a PDCCH indicating unicast scheduling and a PDCCH indicating multicast/broadcast scheduling to control the monitoring behaviors for the PDCCHs, where each LP-WUS is used for indicating waking up monitoring, by the MR, of a PDCCH indicating unicast scheduling or a PDCCH indicating multicast/broadcast scheduling.

The wireless communication method provided by this embodiment includes the following.

1. The UE in a connected state receives multiple sets of LP-WUS configuration information from a base station, where each set of LP-WUS configuration information corresponds to different LP-WUS monitoring resource configurations or different LP-WUS sequences, etc. In this case,
One set of LP-WUS is used for controlling the monitoring, by the UE, of the PDCCH indicating unicast scheduling;
At least one other set of LP-WUS is used for controlling the monitoring, by the UE, of the PDCCH indicating multicast/broadcast scheduling.

Optionally, different LP-WUSs are respectively used to control the monitoring, by the UE, of a PDCCH indicating multicast scheduling and a PDCCH indicating broadcast scheduling.

Optionally, different LP-WUSs are respectively used to control the monitoring, by the UE, of PDCCHs indicating multicast scheduling and scrambled by different RNTIs (such as different G-RNTIs or different G-CS-RNTIs);

Optionally, different LP-WUSs are respectively used to control the monitoring, by the UE, of PDCCHs indicating broadcast scheduling and scrambled by different RNTIs (such as different G-RNTIs or different G-CS-RNTIs).

2. The UE monitors the LP-WUS when the MR is in a sleep or light-sleep state, where the behaviors of the UE when the MR is in the sleep or light-sleep state include the following.
The UE does not monitor a PDCCH indicating unicast scheduling (such as a PDCCH scrambled by C-RNTI or CS-RNTI); and/or
The UE does not monitor a PDCCH indicating multicast and/or broadcast scheduling (such as a PDCCH scrambled by G-RNTI or G-CS-RNTI);

3. After receiving the LP-WUS from the network, an LR of the UE transmits a wake-up indication to the MR, and the MR resumes the monitoring of a PDCCH indicating unicast scheduling or resumes the monitoring of a PDCCH indicating multicast and/or broadcast scheduling according to the indication of the LP-WUS. Specifically, the following cases are included.
Case 1: If the LP-WUS is used for controlling the monitoring, by the UE, of a PDCCH indicating unicast scheduling, after receiving the LP-WUS, the MR of the UE resumes the monitoring of the PDCCH indicating unicast scheduling, and simultaneously maintains the monitoring state of a PDCCH indicating multicast and/or broadcast scheduling unchanged.
Case 2: If the LP-WUS is used for controlling the monitoring, by the UE, of a PDCCH indicating multicast and/or broadcast scheduling, after receiving the LP-WUS, the MR of the UE resumes the monitoring of the PDCCH indicating multicast and/or broadcast scheduling, and simultaneously maintains the monitoring state of a PDCCH indicating unicast scheduling unchanged.
Optionally, if different LP-WUSs are respectively used to control the monitoring, by the UE, of the PDCCH indicating multicast scheduling and the PDCCH indicating broadcast scheduling, then: if the LP-WUS received by the UE is used for controlling the monitoring, by the UE, of the PDCCH indicating multicast scheduling, after receiving the LP-WUS, the MR resumes the monitoring of the PDCCH indicating multicast scheduling, and simultaneously maintains the monitoring state of the PDCCH indicating broadcast scheduling unchanged; if the LP-WUS received by the UE is used for controlling the monitoring, by the UE, of the PDCCH indicating broadcast scheduling, after receiving the LP-WUS, the MR resumes the monitoring of the PDCCH indicating broadcast scheduling, and simultaneously maintains the monitoring state of the PDCCH indicating multicast scheduling unchanged.
Optionally, if different LP-WUSs are respectively used to control the monitoring, by the UE, of PDCCHs indicating multicast/broadcast scheduling scrambled by different RNTIs (such as different G-RNTIs or different G-CS-RNTIs), then: if the LP-WUS received by the UE is used for controlling the monitoring, by the UE, of the PDCCH indicating multicast or broadcast scheduling scrambled by a first RNTI, after receiving the LP-WUS, the MR resumes the monitoring of the PDCCH indicating multicast or broadcast scheduling scrambled by the first RNTI, and simultaneously maintains the monitoring behavior of a PDCCH indicating multicast or broadcast scheduling scrambled by a second RNTI unchanged, where the second RNTI is different from the first RNTI.

The specific manners of resuming PDCCH monitoring are the same as in Embodiment One.

Optionally, the UE executes the above operations after a first time offset following the reception of the LP-WUS.

Embodiments of the present disclosure provide the method of using a low power wake-up signal to waking up the MR of the UE to monitor unicast scheduling and/or multicast and broadcast scheduling. Using this method, the network device can transmit the LP-WUS according to the service transmission requirements of unicast and multicast/broadcast, so that after receiving the LP-WUS signal, the terminal can resume the monitoring of scheduling for specific services as soon as possible, thereby reducing service latency while minimizing the power consumption of the terminal. The method of Embodiment One uses the same LP-WUS to simultaneously control the monitoring, by the MR of the UE, of unicast scheduling and multicast/broadcast scheduling, minimizing signaling overhead. The methods of Embodiment Two and Embodiment Three can achieve separate control of the monitoring, by the MR of the UE, of unicast scheduling and multicast/broadcast scheduling, thereby enabling more flexible control of PDCCH monitoring by the UE.

The above detailed descriptions of the embodiments of the present disclosure are provided in conjunction with the accompanying drawings. However, the present disclosure is not limited to the specific details in the above embodiments. Within the technical conception scope of the present disclosure, various simple modifications can be made to the technical solutions of the present disclosure, and these simple modifications all belong to the protection scope of the present disclosure. For example, various specific technical features described in the above specific embodiments may be combined in any suitable manner without contradiction. To avoid unnecessary repetition, various possible combination manners are not described separately in the present disclosure. For another example, the various different embodiments of the present disclosure may also be combined arbitrarily, and as long as they do not violate the idea of the present disclosure, they should also be regarded as the content disclosed in the present disclosure. For example, without conflict, the various embodiments and/or technical features in the various embodiments described in this disclosure can be arbitrarily combined with the prior art, and the resulting technical solutions should also fall within the protection scope of this disclosure.

It should also be understood that in the various method embodiments of the present disclosure, the magnitude of the serial numbers of the above various processes does not mean the order of execution, and the execution order of each process should be determined by its function and internal logic, and should not constitute any limitation on the implementation process of the embodiments of the present disclosure. In addition, in the embodiments of the present disclosure, the terms “downlink”, “uplink”, and “sidelink” are used to indicate the transmission directions of signals or data, where “downlink” is used to indicate a first direction in which signals or data are transmitted from a site to a UE in a cell, “uplink” is used to indicate a second direction in which signals or data are transmitted from the UE in the cell to the site, and “sidelink” is used to indicate a third direction in which signals or data are transmitted from UE 1 to UE 2. For example, a “downlink signal” indicates that the transmission direction of the signal is the first direction. In addition, in the embodiments of the present disclosure, the term “and/or” is merely an association relationship describing associated objects, indicating that there may be three relationships. Specifically, A and/or B may indicate: A exists alone, both A and B exist simultaneously, and B exists alone. In addition, the character “/” herein generally indicates that the associated objects before and after it have an “or” relationship.

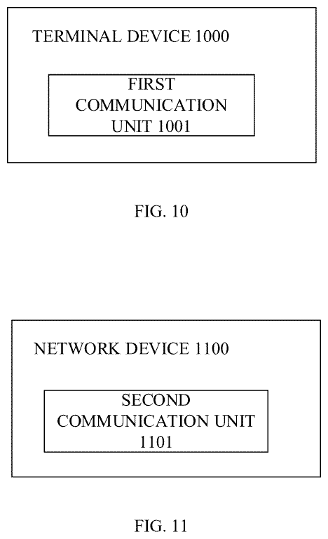

FIG. 10 is a first schematic structural diagram of a terminal device provided by an embodiment of the present disclosure. As illustrated in FIG. 10, a terminal device 1000 includes a first communication unit 1001.

The first communication unit 1001 is configured to receive an LP-WUS transmitted by a network device, where the LP-WUS is used for controlling monitoring, by an MR of the terminal device, of a first PDCCH and/or a second PDCCH, the first PDCCH is a PDCCH indicating unicast scheduling, and the second PDCCH is a PDCCH indicating multicast and/or broadcast scheduling.

In some embodiments, the LP-WUS is used for controlling the monitoring, by the MR, of the first PDCCH and the second PDCCH.

In some embodiments, the LP-WUS indicating wake-up is used for waking up the monitoring, by the MR, of the first PDCCH and the second PDCCH.

In some embodiments, the terminal device 1000 further includes a first resumption unit configured to resume, based on the LP-WUS indicating wake-up, the monitoring of the first PDCCH and the second PDCCH by the MR.

In some embodiments, the LP-WUS indicating wake-up is further used for controlling the MR to enter a wake-up state from a sleep state, where the MR performs monitoring of the first PDCCH and the second PDCCH in the wake-up state.

In some embodiments, the terminal device does not monitor the first PDCCH and the second PDCCH when the MR is in the sleep state.

In some embodiments, the LP-WUS is used for controlling the monitoring, by the MR, of the first PDCCH and/or the second PDCCH indicated by the LP-WUS.

In some embodiments, the LP-WUS indicating wake-up is used for waking up the monitoring, by the MR, of the first PDCCH and/or the second PDCCH indicated by the LP-WUS.

In some embodiments, the terminal device 1000 further includes a second resumption unit configured to: if the LP-WUS indicates the first PDCCH, resume, based on the LP-WUS indicating wake-up, the monitoring of the first PDCCH by the MR.

In some embodiments, a monitoring state of the second PDCCH remains unchanged.

In some embodiments, the terminal device 1000 further includes a third resumption unit configured to: if the LP-WUS indicates the second PDCCH, resume, based on the LP-WUS indicating wake-up, the monitoring of the second PDCCH by the MR.

In some embodiments, a monitoring state of the first PDCCH remains unchanged.

In some embodiments, the terminal device 1000 further includes a fourth resumption unit configured to: if the LP-WUS indicates the first PDCCH and the second PDCCH, resume, based on the LP-WUS indicating wake-up, the monitoring of the first PDCCH and the second PDCCH by the MR.

In some embodiments, the LP-WUS used for indicating wake-up is further used for controlling the MR to enter a wake-up state from a sleep state, where the MR performs monitoring of the first PDCCH and/or the second PDCCH in the wake-up state.

In some embodiments, the terminal device does not monitor the first PDCCH and/or the second PDCCH when the MR is in the sleep state.

In some embodiments, if the LP-WUS indicates the second PDCCH, the LP-WUS indicates one or more of the following:
a PDCCH indicating multicast scheduling and/or a PDCCH indicating broadcast scheduling;
a PDCCH indicating multicast or broadcast scheduling and scrambled by an RNTI.

In some embodiments, the first communication unit 1001 is further configured to receive a first configuration information configured by the network device, where the first configuration information is used for monitoring of the LP-WUS.

In some embodiments, the LP-WUS is used for controlling the monitoring, by the MR, of a target PDCCH corresponding to the LP-WUS, where the target PDCCH is the first PDCCH or the second PDCCH.

In some embodiments, the LP-WUS is one of multiple LP-WUSs, the multiple LP-WUSs include:
a first LP-WUS used for controlling the monitoring, by the MR, of the first PDCCH; and
one or more second LP-WUSs used for controlling the monitoring, by the MR, of the second PDCCH.

In some embodiments, different second LP-WUSs among the multiple second LP-WUSs are used for:
controlling monitoring of a PDCCH indicating multicast scheduling or a PDCCH indicating broadcast scheduling; or,
controlling monitoring of a PDCCH indicating multicast or broadcast scheduling and scrambled by different RNTIs.

In some embodiments, the LP-WUS indicating wake-up is used for waking up the monitoring, by the MR, of the target PDCCH corresponding to the LP-WUS.

In some embodiments, the terminal device 1000 further includes a fourth resumption unit configured to resume, based on the LP-WUS indicating wake-up, the monitoring of the target PDCCH by the MR.

In some embodiments, the fourth resumption unit is further configured to: if the LP-WUS is a first LP-WUS corresponding to the first PDCCH, resume, based on the first LP-WUS indicating wake-up, the monitoring of the first PDCCH by the MR.

In some embodiments, a monitoring state of the second PDCCH remains unchanged.

In some embodiments, the fourth resumption unit is further configured to: if the LP-WUS is a second LP-WUS corresponding to the second PDCCH, resume, based on the second LP-WUS indicating wake-up, the monitoring of the second PDCCH by the MR.

In some embodiments, a monitoring state of the first PDCCH remains unchanged.

In some embodiments, if the second PDCCH corresponding to the second LP-WUS is a PDCCH indicating multicast scheduling, a monitoring state of a PDCCH indicating broadcast scheduling remains unchanged.

In some embodiments, if the second PDCCH corresponding to the second LP-WUS is a PDCCH indicating broadcast scheduling, a monitoring state of a PDCCH indicating multicast scheduling remains unchanged.

In some embodiments, if the second PDCCH corresponding to the second LP-WUS is a PDCCH indicating multicast or broadcast scheduling and scrambled by a first RNTI, a monitoring state of a PDCCH indicating multicast or broadcast scheduling and scrambled by a second RNTI remains unchanged.

In some embodiments, the LP-WUS used for indicating wake-up is further used for controlling the MR to enter a wake-up state from a sleep state, where the MR performs monitoring of the target PDCCH corresponding to the LP-WUS in the wake-up state.

In some embodiments, the terminal device does not monitor the first PDCCH and/or the second PDCCH when the MR is in the sleep state.

In some embodiments, the first communication unit 1001 is further configured to receive multiple second configuration information configured by the network device, where the multiple second configuration information are used for monitoring of the multiple LP-WUSs.

In some embodiments, a manner of resuming the monitoring, by the MR, of the first PDCCH include one of the following:
starting a DRX on-duration timer corresponding to unicast DRX;
monitoring a wake-up signal upon receiving the LP-WUS used for resuming the monitoring of the first PDCCH, and starting a DRX on-duration timer corresponding to unicast DRX when the wake-up signal is detected;
starting a first timer corresponding to unicast DRX, where the terminal device is in an active time of unicast DRX during operation of the first timer; and
entering an active time of unicast DRX.

In some embodiments, a manner of resuming the monitoring, by the MR, of the second PDCCH include one of the following:
starting a DRX on-duration timer corresponding to multicast or broadcast DRX;
starting a second timer corresponding to multicast or broadcast DRX, where the terminal device is in an active time of multicast or broadcast DRX during operation of the second timer; and
entering an active time of multicast or broadcast DRX.

In some embodiments, the execution of using the LP-WUS to control the monitoring, by the MR of the terminal device, of the first PDCCH and/or the second PDCCH is performed after a first time offset following a first time, where the first time is a time of receiving the LP-WUS.

The first communication unit in the terminal device may be implemented by a transceiver in the terminal device. The first resumption unit, the second resumption unit, the third resumption unit, and the fourth resumption unit in the terminal device may be implemented by a processor in the terminal device.

FIG. 11 is a first schematic structural diagram of a network device provided by an embodiment of the present disclosure. As illustrated in FIG. 11, a network device 1100 includes a second communication unit 1201.

The second communication unit 1201 is configured to transmit an LP-WUS to a terminal device, where the LP-WUS is used for controlling transmission of a first PDCCH and/or a second PDCCH to the terminal device, the first PDCCH is a PDCCH indicating unicast scheduling, and the second PDCCH is a PDCCH indicating multicast and/or broadcast scheduling.

In some embodiments, the LP-WUS is used for controlling transmission of the first PDCCH and the second PDCCH.

In some embodiments, the LP-WUS indicating wake-up is used for indicating resumption of the transmission of the first PDCCH and the second PDCCH.

In some embodiments, the network device 1100 further includes a first control unit configured to resume, based on the LP-WUS indicating wake-up, the transmission of the first PDCCH and the second PDCCH.

In some embodiments, the network device does not transmit the first PDCCH and the second PDCCH to the terminal device before resuming the transmission of the first PDCCH and the second PDCCH.

In some embodiments, the LP-WUS is used for controlling transmission of the first PDCCH and/or the second PDCCH indicated by the LP-WUS.

In some embodiments, the LP-WUS indicating wake-up is used for resuming the transmission of the first PDCCH and/or the second PDCCH indicated by the LP-WUS.

In some embodiments, the network device 1100 further includes a second control unit configured to: if the LP-WUS indicates the first PDCCH, resume, based on the LP-WUS indicating wake-up, transmission of the first PDCCH.

In some embodiments, a transmission state of the second PDCCH remains unchanged.

In some embodiments, the network device 1100 further includes a third control unit configured to: if the LP-WUS indicates the second PDCCH, resume, based on the LP-WUS indicating wake-up, transmission of the second PDCCH.

In some embodiments, a transmission state of the first PDCCH remains unchanged.

In some embodiments, the network device 1100 further includes a fourth control unit configured to: if the LP-WUS indicates the first PDCCH and the second PDCCH, resume, based on the LP-WUS indicating wake-up, the transmission of the first PDCCH and the second PDCCH

In some embodiments, the network device does not transmit the first PDCCH and/or the second PDCCH before resuming the transmission of the first PDCCH and/or the second PDCCH.

In some embodiments, if the LP-WUS indicates the second PDCCH, the LP-WUS indicates one or more of:
a PDCCH indicating multicast scheduling and/or a PDCCH indicating broadcast scheduling; and
a PDCCH, scrambled by an RNTI, indicating multicast or broadcast scheduling.

In some embodiments, the second communication unit 1101 is further configured to configure one first configuration information for the terminal device, where the first configuration information is used for monitoring of the LP-WUS.

In some embodiments, the LP-WUS is used for controlling transmission of a target PDCCH corresponding to the LP-WUS, where the target PDCCH is the first PDCCH or the second PDCCH.

In some embodiments, the LP-WUS is one of multiple LP-WUSs. The multiple LP-WUSs include:
a first LP-WUS used for controlling transmission of the first PDCCH; and
one or more second LP-WUSs used for controlling transmission of the second PDCCH.

In some embodiments, different second LP-WUSs among the multiple second LP-WUSs are used for:
controlling transmission of a PDCCH indicating multicast scheduling or a PDCCH indicating broadcast scheduling; or
controlling transmission of PDCCHs, scrambled by different RNTIs, indicating multicast or broadcast scheduling.

In some embodiments, the LP-WUS indicating wake-up is used for resuming the transmission of the target PDCCH corresponding to the LP-WUS.

In some embodiments, the network device 1100 further includes a fifth control unit configured to resume, based on the LP-WUS indicating wake-up, the transmission of the target PDCCH.

In some embodiments, the fifth control unit is further configured to: if the LP-WUS is a first LP-WUS corresponding to the first PDCCH, resume, based on the first LP-WUS indicating wake-up, transmission of the first PDCCH.

In some embodiments, a transmission state of the second PDCCH remains unchanged.

In some embodiments, the fifth control unit is further configured to: if the LP-WUS is a second LP-WUS corresponding to the second PDCCH, resume, based on the second LP-WUS indicating wake-up, transmission of the second PDCCH.

In some embodiments, a transmission state of the first PDCCH remains unchanged.

In some embodiments, if the second PDCCH corresponding to the second LP-WUS is a PDCCH indicating multicast scheduling, a transmission state of a PDCCH indicating broadcast scheduling remains unchanged.

In some embodiments, if the second PDCCH corresponding to the second LP-WUS is a PDCCH indicating broadcast scheduling, a transmission state of a PDCCH indicating multicast scheduling remains unchanged.

In some embodiments, if the second PDCCH corresponding to the second LP-WUS is a PDCCH indicating multicast or broadcast scheduling and scrambled by a first RNTI, a transmission state of a PDCCH indicating multicast or broadcast scheduling and scrambled by a second RNTI remains unchanged.

In some embodiments, the network device does not transmit the first PDCCH and/or the second PDCCH before resuming transmission of the target PDCCH.

In some embodiments, the second communication unit 1101 is further configured to configure multiple second configuration information for the terminal device, where the multiple second configuration information are used for monitoring of the multiple LP-WUSs

In some embodiments, the LP-WUS is used for controlling the transmission of the first PDCCH and/or the second PDCCH to the terminal device to be performed after a first time offset following a second time, the second time being a time of transmitting the LP-WUS.

The second communication unit in the network device may be implemented by a transceiver in the network device. The first control unit, the second control unit, the third control unit, the fourth control unit, and the fifth control unit in the network device may be implemented by a processor in the network device.

Those skilled in the art should understand that the above descriptions of the terminal device or network device in the embodiments of the present disclosure may be understood with reference to the descriptions of the wireless communication method in the embodiments of the present disclosure.

FIG. 12 is a schematic structural diagram of a communication device 1200 according to an embodiment of the present disclosure. The communication device may be a terminal device or a network device. The communication device 1200 illustrated in FIG. 12 includes a processor 1210. The processor 1210 may invoke and run a computer program from a memory to implement the methods in the embodiments of the present disclosure.

Optionally, as illustrated in FIG. 12, the communication device 1200 may further include a memory 1220. The processor 1210 may invoke and run a computer program from the memory 1220 to implement the methods in the embodiments of the present disclosure.

The memory 1220 may be a separate device independent of the processor 1210, or may be integrated in the processor 1210.

Optionally, as illustrated in FIG. 12, the communication device 1200 may further include a transceiver 1230. The processor 1210 may control the transceiver 1230 to communicate with other devices. Specifically, information or data may be transmitted to other devices, or information or data transmitted by other devices may be received.

The transceiver 1230 may include a transmitter and a receiver. The transceiver 1230 may further include one or more antennas.

Optionally, the communication device 1200 may specifically be the network device in the embodiments of the present disclosure, and the communication device 1200 may implement the corresponding processes implemented by the network device in the various methods of the embodiments of the present disclosure. For brevity, details are not repeated herein.

Optionally, the communication device 1200 may specifically be the mobile terminal/terminal device in the embodiments of the present disclosure, and the communication device 1200 may implement the corresponding processes implemented by the mobile terminal/terminal device in the various methods of the embodiments of the present disclosure. For brevity, details are not repeated herein.

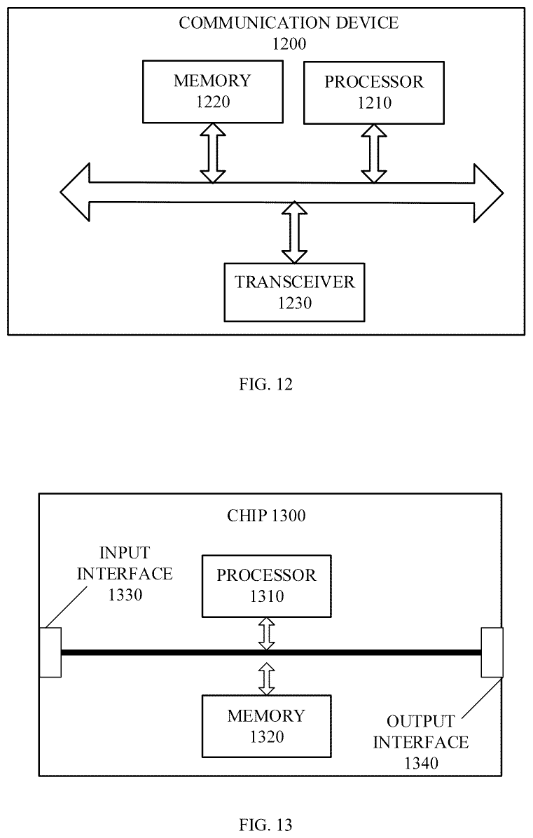

FIG. 13 is a schematic structural diagram of a chip 1300 according to an embodiment of the present disclosure. The chip 1300 illustrated in FIG. 13 includes a processor 1310. The processor 1310 may invoke and run a computer program from a memory to implement the methods in the embodiments of the present disclosure.

Optionally, as illustrated in FIG. 13, the chip 1300 may further include a memory 1320. The processor 1310 may invoke and run a computer program from the memory 1320 to implement the methods in the embodiments of the present disclosure.

The memory 1320 may be a separate device independent of the processor 1310, or may be integrated in the processor 1310.

Optionally, the chip 1300 may further include an input interface 1330. The processor 1310 may control the input interface 1330 to communicate with other devices or chips. Specifically, information or data transmitted by other devices or chips may be obtained.

Optionally, the chip 1300 may further include an output interface 1340. The processor 1310 may control the output interface 1340 to communicate with other devices or chips. Specifically, information or data may be output to other devices or chips.

Optionally, the chip may be applied to the network device in the embodiments of the present disclosure, and the chip may implement the corresponding processes implemented by the network device in the various methods of the embodiments of the present disclosure. For brevity, details are not repeated herein.

Optionally, the chip may be applied to the mobile terminal/terminal device in the embodiments of the present disclosure, and the chip may implement the corresponding processes implemented by the mobile terminal/terminal device in the various methods of the embodiments of the present disclosure. For brevity, details are not repeated herein.

It should be understood that the chip mentioned in the embodiments of the present disclosure may also be called a system-level chip, a system chip, a chip system, or a system-on-chip, etc.

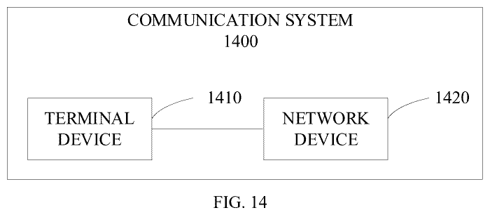

FIG. 14 is a schematic block diagram of a communication system 1400 according to an embodiment of the present disclosure. As illustrated in FIG. 14, the communication system 1400 includes a terminal device 1410 and a network device 1420.

The terminal device 1410 may be used for implementing the corresponding functions implemented by the terminal device in the above methods, and the network device 1420 may be used for implementing the corresponding functions implemented by the network device in the above methods. For brevity, details are not repeated herein.

It should be understood that the processor in the embodiments of the present disclosure may be an integrated circuit chip with signal processing capabilities. In the implementation process, the various steps of the method embodiments may be completed by integrated logic circuits in the processor or instructions in the form of software. The above processor may be a general-purpose processor, a Digital Signal Processor (DSP), an Application Specific Integrated Circuit (ASIC), a Field Programmable Gate Array (FPGA) or other programmable logic devices, discrete gate or transistor logic devices, or discrete hardware components. The various methods, steps, and logic block diagrams disclosed in the embodiments of the present disclosure may be implemented or executed. The general-purpose processor may be a microprocessor or any conventional processor. The steps of the methods disclosed in the embodiments of the present disclosure may be directly embodied as being executed and completed by a hardware decoding processor, or by a combination of hardware and software modules in the decoding processor. The software module may be located in a mature storage medium in the art, such as a Random Access Memory, a flash memory, a Read-Only Memory, a Programmable Read-Only Memory, an Electrically Erasable Programmable Memory, or a register. The storage medium is located in the memory, and the processor reads the information in the memory and completes the steps of the above methods in combination with its hardware.

It can be understood that the memory in the embodiments of the present disclosure may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external high-speed cache. By way of example but not limitation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synchronous Link DRAM (SLDRAM), and Direct Rambus RAM (DR RAM). It should be noted that the memory of the systems and methods described herein is intended to include, without limitation, these and any other suitable types of memory.

It should be understood that the above memory is exemplary but not limiting. For example, the memory in the embodiments of the present disclosure may also be Static RAM (SRAM), Dynamic RAM (DRAM), Synchronous DRAM (SDRAM), Double Data Rate SDRAM (DDR SDRAM), Enhanced SDRAM (ESDRAM), Synchronous Link DRAM (SLDRAM), and Direct Rambus RAM (DR RAM), etc. That is, the memory in the embodiments of the present disclosure is intended to include, without limitation, these and any other suitable types of memory.

Embodiments of the present disclosure also provide a computer-readable storage medium for storing a computer program.

Optionally, the computer-readable storage medium may be applied to the network device in the embodiments of the present disclosure, and the computer program causes a computer to execute the corresponding processes implemented by the network device in the various methods of the embodiments of the present disclosure. For brevity, details are not repeated here.

Optionally, the computer-readable storage medium may be applied to the mobile terminal/terminal device in the embodiments of the present disclosure, and the computer program causes a computer to execute the corresponding processes implemented by the mobile terminal/terminal device in the various methods of the embodiments of the present disclosure. For brevity, details are not repeated here.

Embodiments of the present disclosure also provide a computer program product including computer program instructions.

Optionally, the computer program product may be applied to the network device in the embodiments of the present disclosure, and the computer program instructions cause a computer to execute the corresponding processes implemented by the network device in the various methods of the embodiments of the present disclosure. For brevity, details are not repeated here.

Optionally, the computer program product may be applied to the mobile terminal/terminal device in the embodiments of the present disclosure, and the computer program instructions cause a computer to execute the corresponding processes implemented by the mobile terminal/terminal device in the various methods of the embodiments of the present disclosure. For brevity, details are not repeated here.

Embodiments of the present disclosure also provide a computer program.

Optionally, the computer program may be applied to the network device in the embodiments of the present disclosure. When the computer program runs on a computer, it causes the computer to execute the corresponding processes implemented by the network device in the various methods of the embodiments of the present disclosure. For brevity, details are not repeated here.

Optionally, the computer program may be applied to the mobile terminal/terminal device in the embodiments of the present disclosure. When the computer program runs on a computer, it causes the computer to execute the corresponding processes implemented by the mobile terminal/terminal device in the various methods of the embodiments of the present disclosure. For brevity, details are not repeated here.

Those skilled in the art may realize that the units and algorithm steps of the various examples described in combination with the embodiments disclosed herein can be implemented by electronic hardware or a combination of computer software and electronic hardware. Whether these functions are executed in hardware or software depends on the specific application and design constraints of the technical solution. Professional technicians may use different methods for each specific application to implement the described functions, but such implementation should not be considered beyond the scope of the present disclosure.

Those skilled in the art may clearly understand that for convenience and brevity of description, the specific working processes of the above-described systems, devices, and units may refer to the corresponding processes in the foregoing method embodiments, and details are not repeated here.

In the several embodiments provided in the present disclosure, it should be understood that the disclosed systems, devices, and methods may be implemented in other manners. For example, the device embodiments described above are merely schematic. For example, the division of the units is only a logical function division. In actual implementation, there may be other division manners. For example, multiple units or components may be combined or may be integrated into another system, or some features may be ignored or not executed. In addition, the displayed or discussed mutual coupling or direct coupling or communication connection may be indirect coupling or communication connection through some interfaces, devices, or units, and may be in electrical, mechanical, or other forms.

The units described as separate parts may or may not be physically separated. The parts displayed as units may or may not be physical units, that is, they may be located in one place, or may be distributed to multiple network units. Some or all of the units may be selected according to actual needs to achieve the objectives of the solutions of the embodiments.

In addition, the various functional units in the various embodiments of the present disclosure may be integrated into one processing unit, or each unit may exist separately physically, or two or more units may be integrated into one unit.

If the functions are implemented in the form of software functional units and sold or used as independent products, they may be stored in a computer-readable storage medium. Based on such understanding, the technical solutions of the present disclosure essentially, or the part contributing to the prior art, or part or all of the technical solutions may be embodied in the form of a software product. The computer software product is stored in a storage medium, including several instructions to cause a computer device (which may be a personal computer, a server, or a network device, etc.) to execute all or part of the steps of the methods described in the various embodiments of the present disclosure. The foregoing storage medium includes: a U disk, a mobile hard disk, a Read-Only Memory (ROM), a Random Access Memory (RAM), a magnetic disk, or an optical disk, and other media that can store program codes.

The above descriptions are only preferred embodiments of the present disclosure and are not intended to limit the protection scope of the present disclosure. Any modifications, equivalent replacements, improvements, etc. made within the spirit and principles of the present disclosure shall be included in the protection scope of the present disclosure.

What is claimed is:

1. A wireless communication method, comprising:
receiving, by a terminal device, a low power wake-up signal (LP-WUS) transmitted by a network device, wherein the LP-WUS is used for controlling monitoring, by a main radio (MR) of the terminal device, of a first physical downlink control channel (PDCCH) and/or a second PDCCH, the first PDCCH is a PDCCH indicating unicast scheduling, and the second PDCCH is a PDCCH indicating multicast and/or broadcast scheduling.

2. The method according to claim 1, wherein the LP-WUS is used for controlling the monitoring, by the MR, of a target PDCCH corresponding to the LP-WUS, the target PDCCH being the first PDCCH or the second PDCCH.

3. The method according to claim 2, wherein the LP-WUS indicating wake-up is used for waking up the monitoring, by the MR, of the target PDCCH corresponding to the LP-WUS.

4. The method according to claim 3, further comprising:
resuming, by the terminal device based on the LP-WUS indicating wake-up, the monitoring of the target PDCCH by the MR.

5. The method according to claim 4, wherein resuming, by the terminal device based on the LP-WUS indicating wake-up, the monitoring of the target PDCCH by the MR comprises:
if the LP-WUS is a first LP-WUS corresponding to the first PDCCH, resuming, by the terminal device based on the first LP-WUS indicating wake-up, the monitoring of the first PDCCH by the MR.

6. The method according to claim 5, wherein a monitoring state of the second PDCCH remains unchanged.

7. The method according to claim 2, wherein the LP-WUS indicating wake-up is further used for controlling the MR to enter a wake-up state from a sleep state, wherein the MR performs monitoring of the target PDCCH corresponding to the LP-WUS in the wake-up state.

8. The method according to claim 7, wherein the terminal device does not monitor the first PDCCH and/or the second PDCCH when the MR is in the sleep state.

9. The method according to claim 5, wherein a manner of resuming the monitoring of the first PDCCH by the MR comprises one of the following:
starting a discontinuous reception (DRX) on-duration timer corresponding to unicast DRX;
monitoring a wake-up signal upon receiving the LP-WUS used for resuming monitoring of the first PDCCH, and starting a DRX on-duration timer corresponding to unicast DRX when the wake-up signal is detected;
starting a first timer corresponding to unicast DRX, wherein the terminal device is in an active time of unicast DRX during operation of the first timer; or
entering an active time of unicast DRX.

10. The method according to claim 1, wherein the LP-WUS is used for controlling the monitoring, by the MR of the terminal device, of the first PDCCH and/or the second PDCCH to be performed after a first time offset following a first time, the first time being a receiving time of the LP-WUS.

11. A terminal device, comprising:
a processor and a memory configured to store a computer program which, when executed by the processor, causes the terminal device to:
receive a low power wake-up signal (LP-WUS) transmitted by a network device, wherein the LP-WUS is used for controlling monitoring, by a main radio (MR) of the terminal device, of a first physical downlink control channel (PDCCH) and/or a second PDCCH, the first PDCCH is a PDCCH indicating unicast scheduling, and the second PDCCH is a PDCCH indicating multicast and/or broadcast scheduling.

12. A network device, comprising:
a processor and a memory configured to store a computer program which, when executed by the processor, causes the network device to:
transmit a low power wake-up signal (LP-WUS) to a terminal device, wherein the LP-WUS is used for controlling transmission of a first physical downlink control channel (PDCCH) and/or a second PDCCH to the terminal device, the first PDCCH is a PDCCH indicating unicast scheduling, and the second PDCCH is a PDCCH indicating multicast and/or broadcast scheduling.

13. The network device according to claim 12, wherein the LP-WUS is used for controlling transmission of a target PDCCH corresponding to the LP-WUS, the target PDCCH being the first PDCCH or the second PDCCH.

14. The network device according to claim 13, wherein the LP-WUS is one of a plurality of LP-WUSs, the plurality of LP-WUSs comprising:
a first LP-WUS used for controlling transmission of the first PDCCH; and
one or more second LP-WUSs used for controlling transmission of the second PDCCH.

15. The network device according to claim 13, wherein the LP-WUS indicating wake-up is used for resuming the transmission of the target PDCCH corresponding to the LP-WUS.

16. The network device according to claim 15, further comprising:
resuming, by the network device based on the LP-WUS indicating wake-up, the transmission of the target PDCCH.

17. The network device according to claim 16, wherein resuming, by the network device based on the LP-WUS indicating wake-up, the transmission of the target PDCCH comprises:
if the LP-WUS is a first LP-WUS corresponding to the first PDCCH, resuming, by the network device based on the first LP-WUS indicating wake-up, transmission of the first PDCCH.

18. The network device according to claim 17, wherein a transmission state of the second PDCCH remains unchanged.

19. The network device according to claim 16, wherein the network device does not transmit the first PDCCH and/or the second PDCCH before resuming transmission of the target PDCCH.

20. The network device according to claim 12, wherein the LP-WUS is used for controlling the transmission of the first PDCCH and/or the second PDCCH to the terminal device to be performed after a first time offset following a second time, the second time being a time of transmitting the LP-WUS.
